(19) United States
(12) Patent Application Publication
(10) Pub. No.: US 2008/0010189 A1
(43) Pub. Date: Jan. 10, 2008

(54) Multiple account multiple parameter debit method, apparatus and systems for transaction processor

(76) Inventor: Ronald John Rosenberger, Newtown, PA (US)

Correspondence Address: Guy Kevin Townsend, 19 Sapphire Drive, West Windsor, NJ, 08550, US

(21) Appl. No.: 10/865,188

(22) Filed: Jun. 10, 2004

Related U.S. Application Data
(60) Provisional application No. 60/480,022, filed on Jun. 19, 2003.

(51) Int. Cl. G06Q 40/00

(52) U.S. Cl. 705/39

(57) ABSTRACT

A transaction processor within a global financial card account is provided that enables at least two in-house and/or out-of-house available account balances to be debited in accordance to at least one ratio, and/or other parameters, such as threshold amount and remainder amount. The transaction processor also allows account-debiting parameters to be set in accordance to any merchant identifier information, and permits account balances used for a given transaction to be readjusted after said transaction has been posted. A smart card embodiment of the transaction processor comprising certain capabilities of the global financial card account embodiment is also presented.

### CROSS REFERENCE TO RELATED APPLICATION

This application claims the benefit of U.S. Provisional Patent Application Ser. No. 60/480,022, filed Jun. 19, 2003, which is entirely incorporated herein by reference.

### BACKGROUND OF THE INVENTION

Imagine being at a store. Your purchases took longer to gather than you had originally anticipated, and you glide your loaded shopping cart up to a relatively short line at a checkout lane to pay for your purchases. You're in a hurry. The customer at the front of the checkout line just had a raft of purchases rung up, and swipes his debit card. His transaction is rejected. He tries again. Rejected again. He goes fishing in his wallet for his credit card, then recalls out loud that he loaned the credit card to his son the day before, and never got it back. He looks in his wallet for cash, and sees that he only has enough cash for about half of the purchases that were rung up. You're running late. He is busy having the clerk scan items to remove them from his transaction total. You're getting steamed. He realizes that he does have enough money to buy the shaving cream after all, and wants the shaving cream added back in to the transaction total. The clerk is stressed. The customer finally notices the tension all around him. He apologizes to everybody within an eight-foot radius. You're turning red. The store manager happens by to see what all the fuss is about. The customer is embarrassed. You realize that the lines at the other checkout lanes have since gotten longer. You're in a hurry. You're late. You're steamed. You're red. You then yank your loaded shopping cart out of line, strand it in the middle of an aisle, and check your watch half dozen times as you tear out of the store until you leap into your car, grind your transmission from Reverse to Drive, and swerve out of the parking lot, just barely missing the kid riding the bike.

Credit card accounts and debit card accounts are well known in the art. Many are single account balance cards that are unusable should the singular account balance become depleted. Some cards access two accounts, such as a credit card account, and a debit card account; however, should the one account chosen to be used be inadequate, the card has to be swiped again, with everybody, from the cashier to the other customers in line at the point-of-sale, bearing witness that the end user was rejected. With regard to credit cards, end users that exceed their credit limit are exposed to varied humiliations, such as rejection of a given point-of-sale transaction, steep credit card over-the-limit fees, etc., whereas with debit cards, end users that exceed their available cash balance for a given point-of-sale transaction are merely rejected . . . in front of everybody.

The dilemma brought about by single balance cards was attempted to be addressed in the field of credit cards, e.g., in U.S. Pat. No. 6,038,552, issued to Fleischl et al., discloses an interest bearing cash account that acts as collateral for an overdrawn condition of the credit card account, where the overdrawn condition is remedied by automatically transferring cash from the interest bearing cash account to the credit card account in an amount which is sufficient to reduce the transaction balance below the credit limit at the end of the billing cycle. The interest bearing cash account itself is not used as a demand account for a given transaction, which would be prohibited under Title 12, Part 329, of the Code of Federal Regulations (C.F.R.) that specifies: No bank shall, directly or indirectly, by any device whatsoever, pay interest on any demand deposit (12 C.F.R. section 329.2). Credit card and debit card accounts comprise typical demand accounts that enable purchases to occur at a point of sale; furthermore, the available cash contained in a typical debit card account comprises a demand deposit. As a result, the interest bearing cash account disclosed in Fleischl et al. is not and cannot be used by itself as a demand account for transactions.

It is important to note that there are two major transaction system components that can be used to transact a purchase at a point of sale. The first is an on line transaction using a PIN (personal identification number), which the end user enters on a PIN pad at the point of sale. On line refers to transactions that use the ACH (automated clearing house) system. ACH transactions occur in real-time, meaning that the actual funds comprising the end user's available cash balance are debited at the time of a purchase transaction using the ACH system, with the same being true for ATM withdrawals that use the ACH system. The PIN number represents the end user's system component of entering and making use of the ACH system. PIN numbers are used for approximately 40% of all debit card transactions, and for ATM (automated teller machine) withdrawals. Pin pads are found at only about 25% of merchant locations; however, the trend is for that number to increase being that PIN-based transactions are relatively cheap for the merchant to engage in.

The second system component is an off line transaction that is signature based. These off line transactions are done on proprietary networks. For example, VISA and MasterCard share a proprietary network, while American Express and Discover Card each have the own proprietary network; furthermore, there is nothing to stop any other well-heeled entities from establishing their own proprietary networks. In these off line transactions, the end user signs for the transaction without using a PIN. These signature-based transactions are not only used for credit card transactions; VISA and MasterCard have signature based debit cards that are used in approximately 60% of all point-of-sale debit card transactions. During the authorization process in an off line transaction, in the event of an accepted transaction (where the transaction authorization request has not been rejected), the available account balance is frozen or reduced by the amount of the authorized transaction, even though the actual funds are not deployed until the transaction is posted. In many cases, the transaction date and the posting date of an off line transaction are different, with the capabilities and activities of the particular transacting merchant being the main factor accounting for the difference. Signature-based transactions require that merchants pay interchange fees, which are a percentage of the transaction, versus a smaller flat fee that is typical of PIN-based transactions; as a result, signature-based transactions tend to be significantly more costly for merchants than PIN-based transactions.

### SUMMARY OF THE INVENTION

The present invention provides multiple account, multiple parameter methods, systems, apparatus, transaction cards, and the like for use in providing at least one point of sale transaction via access to at least two available financial accounts that can be debited by preset parameters relating the amount of the debit to the relative balances available in the two available financial accounts. The preset parameter(s) and access to at least two financial accounts for at least one point of sale transaction provide for solutions related to the problem of accessing and managing debit funds for a point of sale transaction without having to go through the delay and difficulties of having specific accounts have insufficient funds for such debits, as well as for providing automatic, preset access instructions for the at least two financial accounts. Such access and preset parameter(s) allow the financial account user to have automatic access, without the problems associated with the possibility of insufficient accounts, or with having to figure out at the time of the point of sale whether minimum balances or other aspects of the financial account remaining balances are being maintained after the debit is made for the point of sale transaction.

Accordingly, the present invention provides various utilities to the financial account holder, including, but not limited to, being able to access multiple accounts for debiting funds use for a point of sale transaction at a store or other product or service provider, such as internet, telephone, satellite, intranet, and the like.

The present invention further provides the utility of being able to manage financial accounts through preset parameters that can be used to provide, adjust and/or maintain various aspects of the at least two financial accounts, before and after various debit or other financial transactions using such financial accounts, such as, but not limited to, minimum balances, relative balances, debiting using ratios, ranges or relative aspects of the account balances, time related parameters, and other aspects that would be known to one skilled in the relevant arts, e.g., but not limited to finance, banking, business, and the like.

The present invention thus provides at least one multiple account, multiple parameter, method for executing a financial transaction at a point of sale using preset parameters for transferring funds from at least two separate accounts, comprising (a) providing a global financial account comprising at least two financial accounts that can be accessed for debiting of funds for at least one point of sale transaction; and (b) providing a system that supports an external debit from the global financial account, for a point of sale transaction, one or more debit amounts from the at least two financial accounts using at least one preset debit amount parameter selected from any a qualitative or quantitative aspect of at least one said financial accounts. Non-limiting examples of such qualitative or quantitative aspects include, but are not limited to, at least one of a ratio, an amount threshold, a remainder threshold, a minimum available account balance, a maximum available account balance, a minimum debit amount, a range of debit amounts, a maximum debit amount, a qualitative or quantitative aspect of at least one said financial accounts, or any combination thereof. The present invention further provides such a method, wherein the debiting step is conducted using a transaction card, optionally where the transaction card is a smart card. The present invention also provides such a method wherein the debiting step is conducted using a personal identification system, optionally wherein the personal identification system is selected from that uses at least one selected from fingerprint, retinal scan, DNA testing, picture recognition, a personal identification number, code or alpha numeric (PIN).

One benefit of the present invention is to provide the end user with more options and greater flexibility regarding transactions using at least two available account balances. With a single card swipe, it is possible for an end user to make use of at least two available account balances according to parameters the end user has selected, where the available account balances are coordinated and debited in ways that are hitherto unknown. Also, with a single card swipe, it is possible for a depleted account balance to automatically yield to another available account balance so seamlessly that the depleted account balance condition is absolutely invisible to the varied parties in a public point of sale environment, including the end user, thus eliminating varied point of sale embarrassments such as having a depleted available account balance reject the transaction, having to swipe the card again to access another account, having to hunt for another card to swipe, etc.

The present invention can be adapted to function both in PIN-based environments, and signature-based environments. Furthermore, it should be understood that the present invention can be adapted to function in environments that use any other system component of security/verification and/or system routing other than PIN-based or signature based environments. For example, it is only a matter of time before retinal scanning, fingerprints, and/or other unique cardholder physical system component are used in a transaction environment, where such system component are employed as a security measure in conjunction with financial cards, much in the same way a PIN, signature, or electronic signature is presently used in conjunction with financial cards. Furthermore, it is possible that someday a retinal scan, fingerprint, and/or other unique cardholder physical system component is used in place of an actual financial card to access a global account. The present invention is meant to be able to work using currently known networks, such as the ACH or the varied proprietary card networks, or with any future network. Networks using the Internet, such as CyberCash, will no doubt become more and more prevalent as well, especially as security for transactions improve. In any event, the present invention is intended to specifically address how at least two accounts are linked, rather than disclosing limitations that, for example, the overall embodiment can only be PIN-based, signature-based, Internet-based, retinal-based, fingerprint-based, etc.

One aspect of the invention is the use of at least one transaction processor. The transaction processor links together and controls at least two available account balances, and enables parameters to be preset, selected and/or modified with regard to how a given transaction is debited among the at least two available account balances via an interface. The transaction processor facilitates the following:

The transaction processor enables any combination of in-house, or out-of-house available balances to be used.

The transaction processor enables a given transaction to be divided during the transaction among any of the two or more available account balances in accordance with at least one preset ratio.

The transaction processor enables a given transaction to be sorted among any of the two or more available account balances in accordance to at least one preset threshold amount, where transactions up to a specified amount are debited from one available account balance, or from more than one available account balance using any preset ratio, and transactions above the specified amount are debited from a different available account balance, or from more than one available account balance using any preset ratio, with the possibility of employing additional preset threshold or range amounts using any available account balances and/or preset ratios.

The transaction processor enables functions with relation to debiting accounts using remainder amount criteria, split transaction criteria, minimum transaction parameters, various maximum parameters, or criteria based on any merchant identification information.

The transaction processor enables an end user the option to have the transaction processor allow a transaction based on the total of the available account balances, where the transaction processor then debits among the at least two available balances according to set parameters, and compensates for any deficient available account balance(s) using Best Fit criteria that uses at least one other additional available account balance to complete the account debiting.

The transaction processor enables Rescue or Reject criteria that allows an end user the option either to have the transaction processor rescue a given transaction in the event that a specified available account balance is depleted by using at least one other available account balance to complete the transaction; or, to have the transaction processor reject the given transaction in the event of a depleted available account balance.

The transaction processor enables an end user the option to disengage a given available account balance.

The transaction processor enables an end user to readjust or revise how a given transaction is debited among the at least two available account balances after a consummated transaction is posted, either by readjusting global parameters, or by revising actual amounts.

The transaction processor can be realized in two distinct and separate embodiments. The first embodiment is where the transaction processor resides in a global financial account for a given end user, where the global financial account comprises at least two available account balances belonging to the end user. In this case, standard financial cards may be used for transactions, because the ratio and threshold calculations/operations take place within the global financial account, and not from any point of sale location.

The second embodiment is where the transaction processor performing the ratio and threshold calculations/operations resides in the microprocessor on an actual smart data card, and the calculations/operations take place within the smart data card at the actual point of sale location. While the smart data card embodiment does not have all of the features and capabilities of the global financial account embodiment, it is provided nonetheless given the level of interest and attention that smart data cards have garnered in recent years. Either embodiment presents a new realm of flexibility and versatility for the end user.

The present invention provides in one aspect a method for executing at least one debit for at least one point of sale financial transaction using at least one preset transaction parameter relating the debit amount of the debit to the relative account balances in at least two separate financial accounts, comprising: (a) providing at least two financial accounts comprising at least two available balances that can be accessed for the debit for the at least one point of sale transaction; and (b) debiting the debit amount for the at least one point of sale transaction from the at least one of the account balances based on at least one of the preset transaction parameters relating the debit amount to the amounts or ratios of each of the account balances in at least two of the available account balances, wherein the preset transaction parameter is at least one selected from a ratio, an amount threshold, a remainder threshold, a minimum available account balance, a maximum available account balance, a minimum debit amount, a range of debit amounts, a maximum debit amount, or any combination thereof.

Such a method is also provided wherein the debit is conducted using a transaction card, e.g., wherein the transaction card is a magnetic stripe card, a smart card, or a personal identification system, e.g., a personal identification number (PIN), an electronic signature, a fingerprint, a retinal scan, a DNA test, or face or feature recognition.

The present also invention also provides a method for executing at least one debit for at least one point of sale financial transaction using at least one preset transaction parameter relating the debit amount to the relative account balances in at least two financial accounts, comprising: (a) maintaining the at least two financial accounts comprising at least two available account balances that can be debited remotely via a transaction processor according to at least one preset transaction parameter that relates the debit amount to the relative balances in at least two of the available account balances; (b) processing a request for authorization of the transaction amount against the at least two available account balances, in exchange for goods or services, wherein the transaction amount requested is authorized when at least one selected from (i) the total of the at least two available account balances is greater than or equal to the debit amount; (ii) at least one selected available account balance, as determined by the transaction processor, is greater than or equal to the assigned portion of the debit amount corresponding to the at least one selected available account balance; or (iii) at least one selected available account balance, as determined by the transaction processor, is able to compensate for a deficiency in at least one other selected available account balance that is less than the assigned portion of the debit amount corresponding to the at least one selected available account balance using Rescue or Reject criteria, where the assigned portion is determined by the transaction processor; and wherein the transaction amount is debited from or credited to the at least one available account balances by at least one selected from (i) according to the assigned portion determined by the transaction processor, (ii) according to at least one Best Fit criteria; (iii) according to the assigned portion; and (iv) according to Rescue or Reject criteria.

Such a method can optionally further comprise where the available account balances are accessed from at least one point of sale via at least one of an automated clearing house (ACH) network, a proprietary network other than an ACH network, or via the Internet.

Such a methods can optionally further comprise where the at least two available account balances comprise at least one of one or more of (i) available in-house cash balances or available in-house credit balances, (ii) available out-of-house cash balances or available out-of-house credit balances in addition to the available in-house cash balances or the available in-house credit balances, (iii) available out-of-house cash balances or available out-of-house credit balances.

Such a methods can optionally further comprise where at least one of the at least two available account balances comprise its own account number that enables access via a credit card, debit card, ATM card, draft, and the like, where the account number is distinct from the account number(s) used to access the global account.

Such methods can optionally further comprise where the available account balances allow a given end user of the account benefits and reward programs that are available to financial card accounts.

The present invention further provides a system for at least one debit for at least one point of sale financial transaction using at least one preset transaction parameter relating the debit amount to the relative account balances in at least two financial accounts, comprising: (a) a system component for maintaining the at least two financial accounts comprising at least two available account balances that can be debited remotely via a transaction processor according to at least one preset transaction parameter that relates the debit amount to the relative balances in at least two of the available account balances; (b) a system component for processing a request for authorization of the transaction amount against the at least two available account balances, in exchange for goods or services, wherein the transaction amount requested is authorized when at least one selected from (i) the total of the at least two available account balances is greater than or equal to the debit amount; (ii) at least one selected available account balance, as determined by the transaction processor, is greater than or equal to the assigned portion of the debit amount corresponding to the at least one selected available account balance; or (iii) at least one selected available account balance, as determined by the transaction processor, is able to compensate for a deficiency in at least one other selected available account balance that is less than the assigned portion of the debit amount corresponding to the at least one selected available account balance using Rescue or Reject criteria, where the assigned portion is determined by the transaction processor; and wherein the transaction amount is debited from or credited to the at least one available account balances by at least one selected from (i) according to the assigned portion determined by the transaction processor (ii) according to at least one Best Fit criteria; (iii) according to the assigned portion; and (iv) according to Rescue or Reject criteria.

Such a system optionally further comprises including where the at least one two available account balances are accessed from a point-of-sale via at least one selected from an ACH network, any proprietary network other than at least one ACH network, or via the Internet.

Such a system optionally further comprises where the at least two available account balances comprises (i) one or more of available in-house cash balances or available in-house credit balances; (ii) one or more of available out-of-house cash balances or available out-of-house credit balances in addition to the available in-house cash balances or the available in-house credit balances, or (iii) one or more of available out-of-house cash balances or available out-of-house credit balances.

Such a system optionally further comprises where at least one of the available account balances comprising the at least two available account balances has its own account number that enables access via a credit card, debit card, ATM card, draft, and the like, where the account number is distinct from the account number(s) used to access the global account. Such a system optionally further comprises where the at least one two available account balances allow a given end user account benefits and reward programs provided by financial card accounts.

The present invention further provides an apparatus comprising a transaction processor that links together and controls at least two available account balances that enable preset transaction parameters to be selected or modified with regard to how a given transaction is debited among at least two available account balances, where the parameters comprise at least one ratio, and where the transaction processor allows file maintenance functions to be performed, where the parameters can be selected or modified, and the file maintenance functions are performed using an interface. Such an apparatus can optionally further comprise including where the parameters comprise at least one selected from at least one amount threshold or at least one remainder threshold. Such an apparatus can optionally further comprise including where the parameters enable the end user to allow split transactions in a depleted account condition. Such an apparatus can optionally further comprise including where the transaction processor enables the end user or the card entity to make changes or modifications to the parameters via the interface using any communicative system component, format, or technology, from any location, wherein the interface comprises any communicative system component, format, or technology. Such an apparatus can optionally further comprise including where the transaction processor comprises a special instructions file comprising where specific account debiting parameters are associated with any type of merchant identifier information, or any merchant identifier information contained in the merchant identifier text string. Such an apparatus can optionally further comprise including where the special instructions file enables state codes or country codes contained in the merchant identifier information to be set up with specific account debiting parameters. Such an apparatus can optionally further comprise including where the parameters enable at least one given available account balance to be disengaged. Such an apparatus can optionally further comprise including where the parameters enable minimum available balance parameters to be set. Such an apparatus can optionally further comprise including where the parameters enable minimum or maximum allowable transaction amounts to be set.

Such an apparatus can optionally further comprise including where the parameters enable limits to be set on the maximum total debiting of the at least two available account balances over any specified timeframe. Such an apparatus can optionally further comprise including where the parameters enable account-debiting parameters to be adjusted according to specified timeframes. Such an apparatus can optionally further comprise including where the parameters enable limits to be set on the maximum allowable available account balance usage for at least one available account balance comprising the at least two accounts over any specified timeframe; further comprising including where the parameters comprise Best Fit or Rescue and Reject capabilities to deal with any transaction(s) that conflict with the maximum allowable available account balance usage. Such an apparatus can optionally further comprise including where the transaction processor enables a transfer of payment amounts from any available cash balance(s) to make any payment(s) due on transaction amounts charged against any available credit balance(s), comprising where the transfer of the payment amounts are set to occur automatically, or where the end user expedites each transfer individually. Such an apparatus can optionally further comprise including where the transaction processor sends E-mail when the available account balances are used. Such an apparatus can optionally further comprise including where the transaction processor enables separate parameters for cash withdrawals. Such an apparatus can optionally further comprise including where the transaction processor enables separate parameters for check clearance. Such an apparatus can optionally further comprise including where the at least two available account balances comprises an available cash account specifically for cash withdrawals. Such an apparatus can optionally further comprise including where the at least two available account balances comprises an available cash account specifically for check clearance. Such an apparatus can optionally further comprise including where the file maintenance functions enable readjustment or revision with regard to how the given transaction is debited among the at least two available account balances on a post real-time basis after a transaction is posted or otherwise consummated, either by readjusting global parameters, or by revising actual amounts. Such an apparatus can optionally further comprise including where the transaction processor records transaction debiting parameters in order to properly credit returned purchases.

Such an apparatus can optionally further comprise comprising where the interface comprises any format or technology, comprising where the interface may be used directly by the end user, or on behalf of the end user, and comprising where access to the interface comprises any format or technology. Such an apparatus can optionally further comprise including where the transaction comprises the use of a financial card. Such an apparatus can optionally further comprise including where the transaction comprises at least one selected from a cash withdrawal, a draft, an electronic or wire payment. Such an apparatus can optionally further comprise including where the transaction processor sets up electronic and wire payment instructions so that a given set of the electronic and wire payment instructions has its own set of available balance debiting parameters with regard to ratio, threshold, remainder threshold, etc.

The present invention further provides a method where a checking account provider enables an end user to receive free or reduced fee checking services based on the amount of off line fee generating activity, where if the end user performs a specified amount total or number of transactions within a specified period using at least one available credit or available cash balance, where the transactions generate any fee or revenue generating activity, such as interchange fees, or in cases such as American Express, revenues that are deducted and earned from merchant transactions that are not technically considered to be interchange fees, then the end user will receive the free or reduced fee checking services. Such a method can optionally further comprise including where the checking account provider enables the end user to receive the free or reduced fee checking services based on any on line fee or revenue generating activity, either in addition to, or in place of, the off line fee or revenue generating activity, where if the end user performs a specified amount total and/or number of transactions within a specified period using at least one available credit or available cash balance, where the transactions generate any type of fees or revenue, then the end user will receive the free or reduced fee checking services.

The present invention further provides an apparatus comprising a transaction processor that resides on a smart data card that links together and controls at least two available account balances, where the smart data card enables a given transaction to be debited from the at least two available account balances from a point of sale terminal according to parameters, where the parameters comprise at least one ratio, and where the parameters can be selected or modified using a smart data card interface, and where the at least two available account balances comprises any combination of in-house or out-of-house available account balances. Such an apparatus can optionally further comprise including where the parameters comprise at least one amount threshold or at least one remainder threshold. Such an apparatus can optionally further comprise including where the parameters enable at least one given available account balance to be disengaged, minimum available balance parameters to be set, minimum or maximum allowable transaction amounts to be set, Best Fit or Rescue or Reject criteria. Such an apparatus can optionally further comprise where the smart data card interface is part of, is at the site of, or is away from the site of the point of sale terminal.

The present invention is further described by the following description and examples, which do not limit the scope of the present invention, but are representative of the particular aspects of the invention.

### BRIEF DESCRIPTION OF THE DRAWINGS

The above and other features and advantages of the present invention are hereinafter described in the following detailed description of illustrative embodiments to be read in conjunction with the accompanying drawings and figures, wherein like reference numerals are used to identify the same or similar system parts and/or method steps in the similar views, and:

FIG. 1 is a schematic illustration of exemplary interfaces and networks in communication with a transaction processor of the present invention;

FIG. 2 is a schematic corresponding to a transaction processor in communication with an external card service and not internal card service configuration in accordance with an exemplary embodiment;

FIG. 3 is a schematic corresponding to a multiple account provider with an internal transaction processor configured for internal card service in accordance with an exemplary embodiment; and

FIG. 4 is a more detailed schematic of exemplary components of the multiple account transaction processor.

Other aspects and features of the present invention will be more fully apparent from the detailed description that follows.

### DETAILED DESCRIPTION OF THE INVENTION

The present invention provides multiple account, multiple parameter methods, systems, apparatus, transaction cards, and the like for use in providing at least one point of sale transaction via access to at least two available financial accounts that can be debited by preset parameters relating the amount of the debit to the relative balances available in the two available financial accounts. The preset parameter(s) and access to at least two financial accounts for at least one point of sale transaction provide for solutions related the problem of accessing and managing debit funds for a point of sale transaction without having to go through the delay and difficulties of having specific accounts have insufficient funds for such debits, as well as for providing automatic, preset access instructions for the at least two financial accounts. Such access and preset parameter(s) allow the financial account user to have automatic access, without the problems associated with the possibility of insufficient accounts or with having to figure out at the time of the point of sale, whether minimum balances or other aspects of the financial account remaining balances are being maintained after the debit is made for the point of sale transaction.

It is absolutely essential that the term debit, as in to debit an available cash balance or to debit an available credit balance be clearly explained at this time. Some individuals may see the term debit as automatically relating solely to cash accounts, as in the well-known term debit card. Such is not the case with this invention. The terms debit, debits, debiting, debited, etc. as used throughout this invention, are used in the traditional accounting sense mainly as verbs, as defined in Webster's Revised Unabridged Dictionary, © 1996, 1998 MICRA, Inc.: deb-it \Debit\, v. t. [imp. & p. p. Debited; p. pr. & vb. n. Debiting.] 1. To charge with debt;—the opposite of, and correlative to, credit; as, to debit a purchaser for the goods sold. For example, to debit an available cash balance is to have cash or cash equivalents removed from the available cash balance to pay for a debt, which in many cases pertains to purchases that have been made. On the other hand, to debit an available credit balance for, say, a purchase, is to reduce the available credit balance by the purchase amount, where the reduction reflects a consumption of the available credit balance. Relating with the above Webster's debit definition: To charge with debt, this debiting (consumption) of the available credit balance acts to charge the end user with a debt that must be repaid at a later time. For instance, if an end user uses an available credit balance to make a $100 purchase, the available credit balance is debited for the $100 amount, resulting in basically a $100 debt that is owed. Ultimately, the end user will eventually pay off this $100 debt amount sometime in the future.

Also in the invention, the verb credit, in its varied forms, is used. For instance, in the event that a purchase is returned to a merchant by an end user, the merchant credits the balance(s) originally used for the purchase. When the merchant credits an end user's available cash balance, cash pertaining to the purchase amount is restored (returned) to the available cash balance. When the merchant credits an end user's available credit balance, the total consumption of the available credit balance is reduced by the amount of the returned purchase transaction as credited by the merchant. What this basically means is that the total amount of the debt that must be repaid at a later time due to total credit balance consumption by the end user is reduced by the amount of the returned purchase transaction. For example, if an end user has total credit balance usage of $500, and then makes a $100 return to a merchant, once the return gets credited by the merchant, the end user will have to repay the debt based only on the readjusted total available credit balance consumption of $400.

The present invention provides methods and uses of financial cards (or other identity based systems, hereinafter referred to as financial cards) to charge point of sale amounts from one to multiple accounts, as a global account, in a single transaction or connected set of transactions, such that the end user or the financial institution providing the financial card or other identity based system can preset single or multiple parameters for the point of sale transaction to access alternative accounts to provide funds to cover the point of sale transaction, where the account access is other than a demand account that merely covers the amount of insufficient funds in a single account.

The financial card in question can be a regular magnetic stripe card well known to the art. Some card issuers feature magnetic stripe cards with an on-board smart chip; however, in many cases, especially in the United States, the actual chip has seen little, if any use in purchase transactions, as there is a tendency to make use of the smart card's magnetic stripe instead. In any event, magnetic stripe cards with an on-board smart chip may also be employed, although such a card will be used basically for its magnetic stripe capability. It is foreseeable that the actual smart chip could ultimately be useful in facilitating certain transaction aspects, especially with regards to security issues; however, for the time being, any card comprising a standardized magnetic stripe can be used in conjunction with the global account.

Key to this embodiment is the financial card global account belonging to the end user. In terms of present, widely used technology, the global account can be oriented as being PIN-based (on-line using a PIN at the point-of-sale), or signature based (off-line requiring an end-user signature at the point-of-sale), or a combination thereof. As mentioned earlier, it is important to understand that the present invention is not intended to be limited to only PIN-based or signature-based accounts, but may be adapted to use any other system component of security/verification and/or system routing other than PIN-based or signature based system component, comprising retinal scanning, fingerprints, and/or other unique cardholder physical system component, with or without employing a financial card, either using currently known networks, any future network, or the Internet. While banks considering the present invention would tend to favor PIN-based embodiments, and card issuers would tend to favor signature-based embodiments, such is merely an observation, and not a limitation. The global account comprises at least two available account balances. Available account balances fall under two general headings: available cash balance, and available credit balance.

With regard to the available cash balance(s) that may be used for the global account, it is important that the available cash balance(s) earmarked for actual financial card purchase transactions are legally able to be used as a demand account according to 12 C.F.R. (Code of Federal Regulations) section 329.2 mentioned earlier, which is repeated as follows: No bank shall, directly or indirectly, by any device whatsoever, pay interest on any demand deposit. An example of an account that pays interest, and is precluded from being used for financial card purchase transactions according to 12 C.F.R. section 329.2, is a savings account. Available cash balances that may be used includes any type of available cash balance, such as a checking account balance; or cash equivalent balance that can be used for purchases, such as a money market fund, where one unit or share of a money market fund equals, say, one U.S. dollar. Furthermore, should federal regulations somehow change to where interest bearing accounts are permitted to be used as demand accounts, or methods emerge that legally enable interest bearing accounts to be manipulated and used in demand account situations, then such accounts would be deemed usable for purposes of this disclosure as available cash balances.

A very important distinction should be made at this time. Just because an interest-bearing savings account cannot be used for financial card purchase transactions does not necessarily mean that the financial card global account cannot comprise an interest-bearing savings account to good effect. The disclosed financial card global account can comprise at least one interest-bearing non-demand account to enable ATM (automated teller machine) withdrawals. ATM cash withdrawals on interest-bearing savings accounts have absolutely no implications with regard to 12 C.F.R. section 329.2; however, debit card transactions that debit interest-bearing savings accounts are prohibited under 12 C.F.R. section 329.2.

At this time, the term point of sale should be clarified. A kind of point of sale that is readily apparent is at a store, where the end user swipes his financial card in the presence of a merchant or service provider. The term point of sale, as it is used in this invention, is meant to encompass all manners and physical locations that are the origin for the debiting of the global account. Furthermore, the end user does not actually have to be present at the merchant location for the transaction to be considered, for purposes of this invention, as a point of sale transaction. For example, should an end user enter his financial card account number on the website for a given merchant, it is considered a point of sale transaction, even if the end user is making the purchase on a computer in the end user's house. Should an end user phone in a card account number from his home to a merchant; it is considered a point of sale transaction. Should a merchant or service provider automatically debit the global financial account, such as in the case of an automatic monthly payment to the merchant or service provider, it is still considered to be a point of sale transaction for purposes of this invention.

With regard to the plurality of available credit balances, available credit balances comprise three general categories: The first is the revolving credit balance that is used in credit cards, in which an end user pays interest on balances not paid in full after the close of the billing cycle. The second is the charge balance used in charge cards, in which an end user is expected to pay balances in full after the close of the billing cycle. The third is a line of credit, which some banks offer to some end users of checking accounts and/or debit cards. Unlike a revolving credit balance or even a charge balance, typical lines of credit tend to not allow interest-free grace periods for purchase transactions. Also, lines of credit tend not to offer the myriad of credit card type benefits, such as reward programs, purchase protection programs, limited fraud liability, etc. It is envisioned as desirable for embodiments of this invention that make use of at least one available credit balance to avail end users to benefits normally associated with credit card offerings; nonetheless, lines of credit should be considered as extremely usable for embodiments of the present invention that are PIN-based. Furthermore, there are real no obstacles other than costs that prevent an entity that offers a PIN-based embodiment to offer features and benefits to end users of a line of credit that in some or many ways resemble end-user features and benefits of typical of signature-based credit card embodiments. Finally, an available credit balance is meant to include any manner or embodiment of an available credit balance for purposes of this invention, and is not intended to be limited only to a revolving credit balance, charge balance, or line of credit.

The at least two available account balances may comprise any combination of available account balances belonging to an end user. For example, if the plurality comprises two available account balances, the two available account balances can comprise two available cash balances, two available credit balances, or one available cash balance, and one available credit balance. Likewise, if the plurality comprises three or more available account balances, the three or more available account balances can comprise any combination of available cash balances, and/or available credit balances, with the plurality possibly comprising at least one available balance that is specifically used for ATM cash withdrawals that may or may not pay interest.

The at least two available account balances is intended to function under the aegis of the global account; nonetheless, it may be desirable to be able to access a particular available account balance for whatever reason. Therefore, it is possible for at least one of the available account balances comprising the global account to have its own account number that enables access via a credit card, debit card, ATM card, draft, etc., that is distinct from the account number(s) used to access the global account.

A relatively simple and especially effective combination is where the at least two available account balances comprises two available account balances, where one available balance is an available cash balance, and the other is an available credit balance. The chart examples that will be provided later will focus mainly on a global account comprising one available cash balance and one available credit balance. As a side note, it is possible for an end user to open a global account comprising one available cash balance and one available credit balance, and begin to use the account without having the cash account funded by merely using the available credit balance. Then, as the end user becomes more comfortable with the workings of the account, or has ability and/or desire to fund the available cash balance, the end user can then fund the available cash balance and begin to take advantage of the global account's true flexibility.

A vital element to the disclosed global account belonging to an end user is the transaction processor. The transaction processor links together and controls the at least two available account balances. What is especially salient is that the transaction processor enables a given incoming transaction to be debited among the at least two available account balances in accordance with preset parameters. A note about the location of the available account balances is in order. While it is envisioned as being most efficient overall with regards to implementation and costs for the at least two account balances to be maintained at the same financial institution as the global account comprising the transaction processor, where all the available account balances are in-house, it is possible for at least one out-of-house available account balance to be linked to the transaction processor that is part of the global account comprising at least one in-house available account balance. Furthermore, it is disclosed that it is possible to have an embodiment of the transaction processor that works only with out-of-house available account balances, where said embodiment does not comprise any in-house available account balances whatsoever.

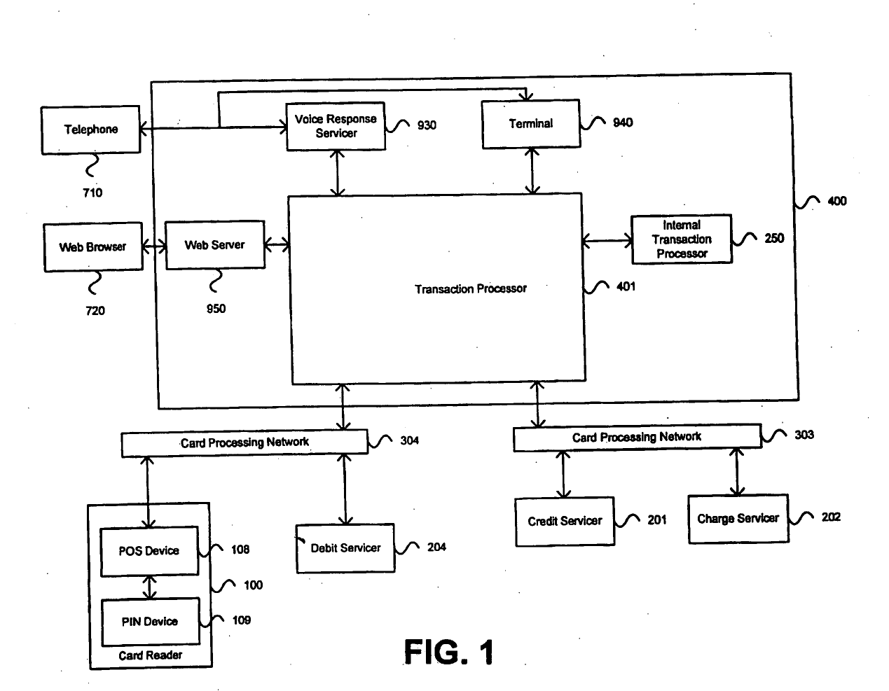

As shown in FIG. 1, an exemplary system and network configuration of the present invention includes a multiple account provider 400 comprising a multiple account transaction processor 400 (and optionally an internal transaction processor 250), one or more user interface systems, e.g., web server 950, voice response servicer 930; and/or a customer service terminal 940; one or more card processing networks 303 or 304; a credit servicer 201; charge servicer 202; debit servicer 204; and/or the like; and a card reader 100, which generally includes a POS device 108 and/or a PIN device 109.

In one embodiment, the cardholder may associate various transaction, global or cash accounts with the card number online. Examples of such elements, as shown in FIG. 1 are a web browser 720 connected to a web server 950 that provides forms for maintenance of multiple account associations and/or a telephone 710 connected to a voice response unit 930 that is capable of decoding spoken or DTMF touchpad tones that the cardholder enters in response to questions that support the maintenance of multiple account associations. Another example is a terminal, such as a computer workstation, or IBM 3270 style terminal, or any other type of display and input device, with which a multiple account provider service representative can perform maintenance of multiple account associations, presumably in response to verbal or written correspondence with the cardholder, as might occur over the telephone at an inbound call processing center. Any combination of elements can be used to create, maintain, and/or delete available account balance associations.

Various exemplary embodiments are contemplated by this invention. In one exemplary embodiment, as depicted in FIG. 1, the invention includes appropriate gateways to communicate with external transaction servicers via a card processing network 303 or 304 to service, for example debit, charge, or credit card accounts. Additionally, an internal transaction processor 250 is disclosed, wherein the internal processor 250 is part of the multiple account provider system and is configured to process card transactions internally.

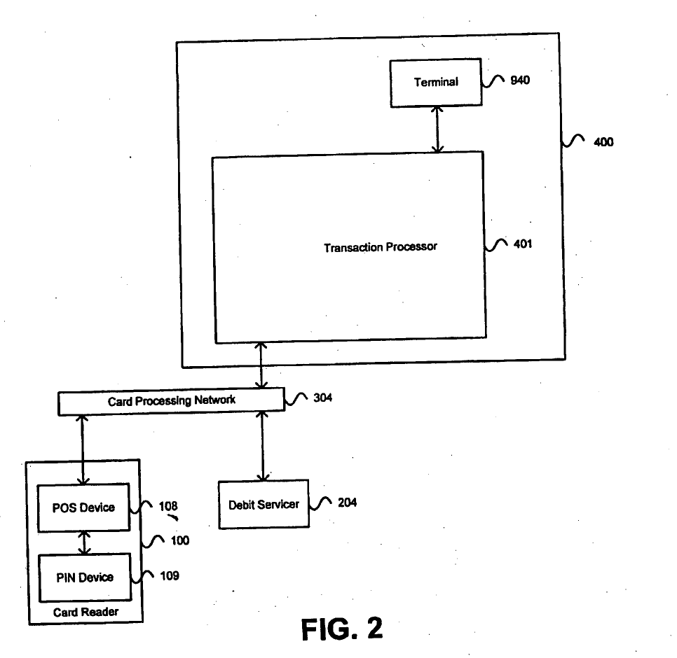

In the exemplary embodiment depicted in FIG. 2, the multiple account system is shown without the internal transaction processor shown in FIGS. 1, 3 and 4, and is configured specifically to support external transaction accounts, i.e., those not maintained and hosted by the multiple account provider. As such, one or more debit servicers 204 may facilitate the processing of transaction accounts not provided by the multiple account provider.

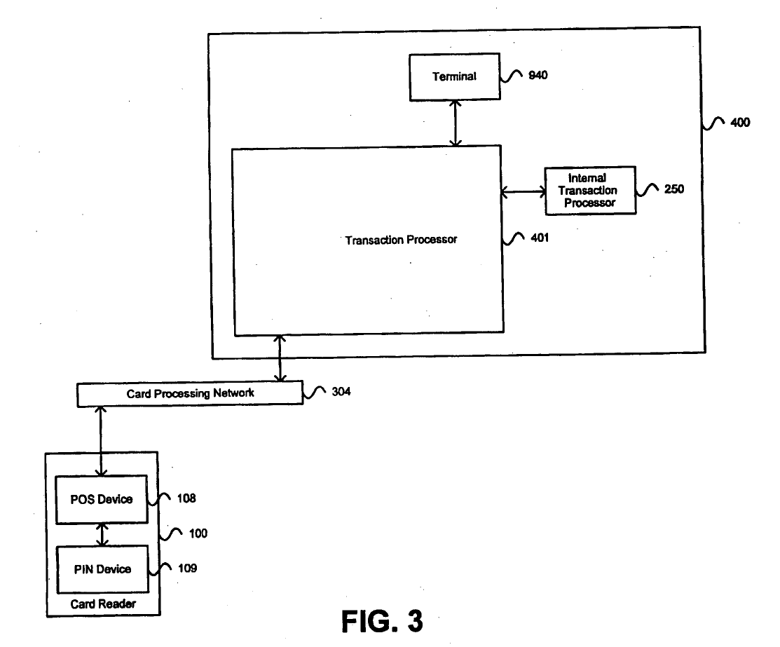

In another exemplary embodiment, where the multiple account number 10 is associated with two or more transaction accounts that are serviced by the subsystems that are internally accessible within the multiple account provider 400, an internal transaction processor 250 is utilized. As such, the architecture shown in FIG. 3 depicts an internal transaction processor 250. In this embodiment, two or more transaction accounts are associated with a cardholder's multiple account number 10. One or more internal transaction processors 250 service the transaction accounts. Transaction processors 250 may facilitate credit transactions, charge transactions, debit transactions, or other kinds of transactions from at least two of the multiple accounts.

In light of the above descriptions, a more detailed description of exemplary components and processes of the present invention is now described, wherein steps for enrolling cardholders, associating transaction accounts to PIN or other identification numbers, and using the multiple account to facilitate transaction events is contemplated.

Enrollment in the multiple account system and subsequent maintenance of the multiple accounts generally comprises elements to facilitate the creation, modification, and deletion of the associations of the multiple account card 5 to two or more transaction accounts. Enrollment establishes a multiple account, account for a cardholder and results in her possession of a multiple account 5 that is ready for card use. In an exemplary embodiment, a cardholder applies for the multiple account 5 using one or more of a variety of mechanisms, such as submission of an on-line form, mail of a paper form, telephone conversation with cardholder service representative, and/or telephone interaction with voice response unit.

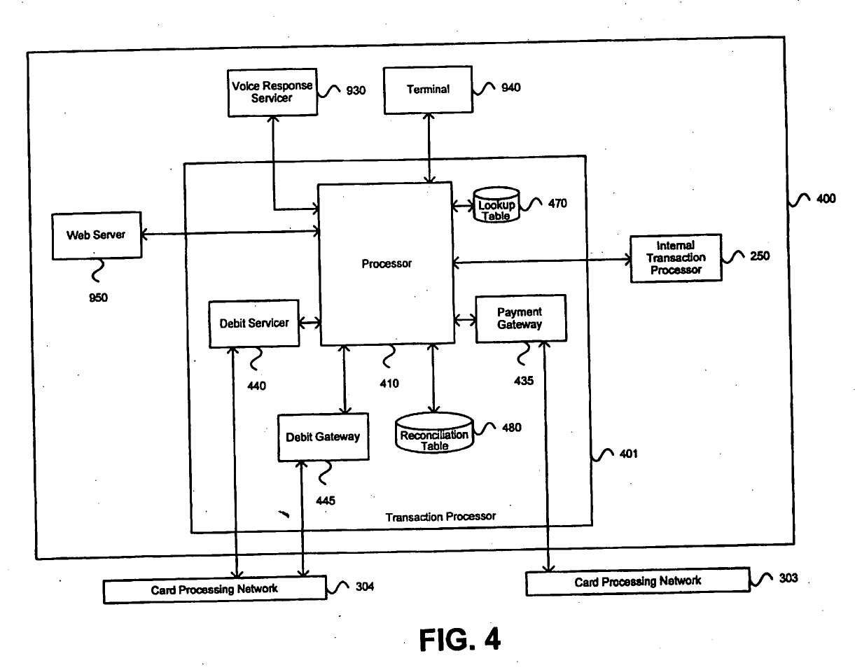

If the mechanism involves a cardholder service representative, then the cardholder service representative enters information into terminal 940. Otherwise, cardholder uses telephone 710 or web browser 720. If cardholder uses web browser 720, then web browser 720 interacts with web server 950. It should be appreciated that any number of means may be used to communicate enrollment data to the multiple account transaction processor 401. The enrollment information provided by the cardholder generally includes appropriate identifying information (e.g., name, addresses, social security number, etc.) so that initial fraud screening and credit determination can be performed. Processor 410 (FIG. 4) determines if the cardholder is to be provided a multiple account.

If the cardholder is to be provided a multiple account, then processor 410 initiates card issuance so that the cardholder will be sent the appropriate plastic card containing a magnetic stripe, smart chip, embossed numbers, and/or the like. The plastic card may be considered a debit card, in that it will later operate similarly to a debit card. In an alternative embodiment, as previously noted, the cardholder does not receive a plastic card; rather, the cardholder only receives a number, digital certificate, or other suitable identification indicia, which may be used online, for example, to facilitate an online transaction event.

In one embodiment, as shown in FIG. 4, the system comprises a lookup table 470 which may be pre-loaded with information about associated transaction accounts, wherein this information may have been previously provided during enrollment. The system may also store cardholder specific information that was provided during enrollment, or which was obtained from other sources, such as, for example: name, address, phone number, multiple account number, and activation information, etc. This information may be stored in a cardholder information table. The system may also store transaction details, which would be initialized during enrollment to contain no transaction records. This information is stored in a transaction record table.

After the cardholder receives the multiple account 5, activation may be desired before use of the multiple account 5 is permitted. Activation may be facilitated by any number of suitable means, for example: calling a cardholder service representative, calling a voice or touch-tone response system, accessing a web site, or any other mechanism in order to provide information about the card and/or cardholder so that the multiple account provider 400 has reasonable certainty that the card was received by the intended cardholder. In an exemplary embodiment, the cardholder calls from their home phone number of record, providing an activation code or account number that was delivered with the multiple account in the mail, possibly in combination with other identifying information such as social security number. The activation mechanism may also obtain information not provided directly by the cardholder by utilizing the communication device used by the cardholder for activation. For example, the activation mechanism may obtain further information from a telephone caller ID or Internet TCP/IP routing or address. After activation, the cardholder may proceed to the steps of card use and/or association of accounts.

Cardholders who are provided with a multiple account 5 may also be provided with authentication credentials for identity verification during subsequent processes. In an exemplary system, the enrolled cardholder is given an ID and password to be used upon subsequent access to the multiple account web site in order to gain access to screens that support multiple account processes. In an alternative embodiment, the cardholder may be prompted to select a password, or answer a secret question, where this information can be used during any or all of the mechanisms for providing information and requesting processes.

The cardholder communicates information to the multiple account processor 401 through one or more of a variety of mechanisms such as submission of on-line form, mail of a paper form, telephone conversation with cardholder service representative, or telephone interaction with voice or touch-tone response unit. The cardholder may be required to provide authentication credentials before proceeding with this process. In an exemplary embodiment, if the cardholder accesses and logs-in to a web site, an ID and password may be required, or an ID and password may be provided for subsequent use at the site, for example, in creating associations. The information provided by the cardholder generally includes: the account number of the transaction account to be associated and a PIN or other identification number 15, and may also include other information such as the name, expiration date, billing address, and other identifying information associated with the particular transaction account.

This information is processed by processor 410 (FIG. 4) to ensure validity and support for the desired transaction account. If supported, then processor 410 adds an association record to the lookup table 470. In an exemplary embodiment, lookup table 470 is a relational database such as Oracle, Sybase, IBM DB2, Microsoft SQL Server, etc., however, it may be any suitable storage system that resides in computer memory, magnetic disk storage, etc., and which optionally includes a database application service that is invoked by database access APIs which might comply with an established standard data access protocol such as SQL. The association record includes some or all of the information provided by the cardholder and may optionally include additional information that is obtained from other sources. In an exemplary embodiment, the association record stores the PIN number, selection card number and/or the account number of the associated transaction account.

A discussion of the capabilities of the transaction processor will center on the varied parameters of the transaction processor. Understand that numerous examples will be presented using specific parameter values, where the values are highly variable, and where the specific values used in the actual examples are somewhat, if not absolutely, arbitrary and represent only a snapshot of a wider range. For example, a parameter value of 50% used in a given example could just as easily be 75%, 33.33%, or even 2%. Furthermore, a given ratio can be expressed and set using any mathematical expression or terminology, such as a percentage (50%); a fraction (½ or one-half); proportion (1 part available balance #1 to 2 parts available balance #2, or 1:2, or 1 to 2); any textual expression (use all cash balance, or use cash, both meaning 100% cash; or, use all credit balance, or use credit, both meaning 100% credit), etc. With regard to threshold amounts, the threshold amounts presented in examples are arbitrary, meaning that, in reality, a threshold amount of $2 can be entered or selected just as readily as a threshold amount of $25, $50, or $100. The specifying of desired parameter values can comprise any manner of data selection or entry, such as where a given parameter value is selected from a listing of parameter values by the end user, where an end user enters a parameter value, etc.

Finally, it should be understood that the available account balances used in examples are readily interchangeable. For instance, a given example that illustrates 100% of a given transaction debiting an available cash balance can be easily revised so that the example shows 100% of a given transaction debiting an available credit balance.

RATIO USING TWO AVAILABLE ACCOUNT BALANCES—One such parameter of the transaction processor comprises having at least one ratio, where an end user can elect to have, for instance, 50% (one-half) of the transaction amount debiting an available cash balance, with the remaining 50% (one-half) debiting an available credit balance. While the examples presented have round U.S. dollar amounts, transactions in U.S. dollars certainly do occur in amounts where an odd dollar amount distributed amongst two or more available account balances would result in fractions of a cent. For example, an amount of $10.01 that is split in a 50/50 ratio amongst two accounts would ordinarily result in each account being debited $5 and one-half cent. Any desired workable solution to this situation may be employed, including where either of the two available account balances gets debited the extra cent, account balances alternate as to which account balance gets debited the extra cent, fractional cents are carried and readjusted at the end of the billing cycle, etc. The solution(s) to the fractional situation could be predetermined by the account provider, or could possibly even be selected by the end user. Also, when considering the examples that will be presented, remember that it is possible for embodiments comprising two available account balances to just as easily comprise two available cash balances (where headings could read “Cash #1” and “Cash #2”), or two available credit balances (where headings could read “Credit #1” and “Credit #2”), in place of the provided examples comprising one available cash balance and one available credit balance. A chart example, showing a month's worth of transactions, is as follows:

| Date | Description | Amount | Cash | Credit |
|---|---|---|---|---|
| 01-02 | Restaurant | 48.00 | 24.00 | 24.00 |
| 01-03 | Gasoline | 21.00 | 10.50 | 10.50 |
| 01-05 | Shoe Store | 36.00 | 18.00 | 18.00 |
| 01-06 | Supermarket | 63.00 | 31.50 | 31.50 |
| 01-14 | Gasoline | 15.00 | 7.50 | 7.50 |
| 01-18 | Appliance Store | 750.00 | 375.00 | 375.00 |
| 01-24 | Gasoline | 18.00 | 9.00 | 9.00 |
| 01-30 | Restaurant | 33.00 | 16.50 | 16.50 |
| | TOTAL | 984.00 | 492.00 | 492.00 |

The ratio using two available account balances can be set in any way, ranging anywhere from where 100% of a given transaction debits an available cash balance (all cash), to where 100% of the transaction debits an available credit balance (all credit), and any point between the two extremes.

Examples demonstrating 100% of a given available account balance, with varied circumstances, will now be presented.

RATIO USING TWO AVAILABLE ACCOUNT BALANCES—DEPLETION EXAMPLE—SPLIT TRANSACTIONS PERMITTED—This example shows where the end user uses a ratio of 100% of the available cash balance, but where, at the point of depletion of the cash balance, the end user not only permits the available credit balance to take over, but also permits a given transaction to be split between the available cash and the available credit balance. In this example, the card not only shifts seamlessly from acting as a debit card to acting as a credit card, but also does so during the transaction dated 01-05.

| Date | Description | Amount | Cash | Credit |
|---|---|---|---|---|
| AVAILABLE CASH BALANCE OF THE DEBIT CARD | | | | |
| CASH ACCOUNT - $100.00 | | | | |
| 01-02 | Restaurant | 48.00 | 48.00 | -0- |
| 01-03 | Gasoline | 21.00 | 21.00 | -0- |
| 01-05 | Shoe Store | 36.00 | 31.00 | 5.00 |
| AVAILABLE CASH DEPLETED - REMAINDER TAKEN | | | | |
| FROM AVAILABLE CREDIT BALANCE | | | | |
| 01-06 | Supermarket | 63.00 | -0- | 63.00 |
| 01-14 | Gasoline | 15.00 | -0- | 15.00 |
| 01-18 | Appliance Store | 750.00 | -0- | 750.00 |
| 01-24 | Gasoline | 18.00 | -0- | 18.00 |
| 01-30 | Restaurant | 33.00 | -0- | 33.00 |
| | TOTAL | 984.00 | 100.00 | 884.00 |

RATIO USING TWO AVAILABLE ACCOUNT BALANCES—DEPLETION EXAMPLE—SPLIT TRANSACTIONS NOT PERMITTED—The following example shows where the end user uses a ratio of 100% of the available cash balance, but where, upon depletion of the $100 cash balance, the end user permits the available credit balance to take over. However, in this example, the end user does not permit a given transaction to be split between the available cash and the available credit balance, and desires that the available cash balance is debited only if the amount in the cash account is enough to pay for a given transaction in full. In this example, the card account shifts back and forth between using available cash and available credit depending on the size of the transaction, as seen in the transaction dated 01-14.

| Date | Description | Amount | Cash | Credit |
|---|---|---|---|---|
| AVAILABLE CASH BALANCE OF THE DEBIT | | | | |
| CASH ACCOUNT PORTION - $100.00 | | | | |
| 01-02 | Restaurant | 48.00 | 48.00 | -0- |
| 01-03 | Gasoline | 21.00 | 21.00 | -0- |
| 01-05 | Shoe Store | 36.00 | -0- | 36.00 |
| AVAILABLE CASH ($31) IS LESS THAN | | | | |
| TRANSACTION AMOUNT | | | | |
| 01-06 | Supermarket | 63.00 | -0- | 63.00 |
| 01-14 | Gasoline | 15.00 | 15.00 | -0- |
| 01-18 | Appliance Store | 750.00 | -0- | 750.00 |
| AVAILABLE CASH ($16) IS LESS THAN | | | | |
| TRANSACTION AMOUNT | | | | |
| 01-24 | Gasoline | 18.00 | -0- | 18.00 |
| 01-30 | Restaurant | 33.00 | -0- | 33.00 |
| | TOTAL | 984.00 | 84.00 | 900.00 |

RATIO USING TWO AVAILABLE ACCOUNT BALANCES—DEPLETION EXAMPLE MAINTAINING A MINIMUM BALANCE—SPLIT TRANSACTIONS PERMITTED—This example shows where the end user uses a ratio of 100% of the available cash balance, but where, upon depletion of the cash balance, the end user permits the available credit balance to take over, where the end user permits a given transaction to be split between the available cash and the available credit balance. However, in this example, the card shifts from using the available cash balance to using the available credit balance while withholding $20 from being used for purchase transactions. Here, a minimum amount is specified to the transaction processor. The transaction processor enables minimums to be maintained on any available account balance as specified by the end user and/or the card entity. There could be one or more of reasons why maintaining a minimum available balance may be desirable. For instance, the card entity may want a minimum cash balance on hand for whatever internal reasons; the end user may want a minimum cash balance on hand that allows an emergency ATM withdrawal without having to pay a cash advance fee, which would happen if a cash withdrawal was to occur on an account having a zero available cash balance; or, if the account was set up where funds from the cash balance are used to pay the minimum payment due on an outstanding credit balance, the end user may want a minimum cash balance on hand to cover the minimum payment due. Minimum available cash balances are also useful in direct deposit situations. For example, an end user that has a direct deposit that credits an available cash balance for $5000 may wish to have $2000 withheld from being used for purchase transactions, where the $2000 amount that is withheld is earmarked and used for writing, say, a check against the available cash balance to pay a mortgage payment. Furthermore, minimum balances could be useful for available credit balances, whereas an end user that has an available credit balance (or “credit limit”) of, say, $7000 does not really wish to use more than $3000 of the available credit balance during any one billing cycle. Here, the end user would specify that he wants to maintain a minimum available credit balance of $4000. Other ways of stating this comprise where the end user specifies that he does not want to use the final $4000 of his available credit balance, or that he wants to consume no more than $3000 of his $7000 available credit balance.

| Date | Description | Amount | Cash | Credit |
|---|---|---|---|---|
| AVAILABLE CASH BALANCE - $100.00 CASH | | | | |
| BALANCE NOT PERMITTED TO GO | | | | |
| BELOW $20.00 | | | | |
| 01-02 | Restaurant | 48.00 | 48.00 | -0- |
| 01-03 | Gasoline | 21.00 | 21.00 | -0- |
| 01-05 | Shoe Store | 36.00 | 11.00 | 25.00 |
| $20 MINIMUM THRESHOLD REACHED - | | | | |
| REMAINDER TAKEN FROM AVAILABLE | | | | |
| CREDIT BALANCE | | | | |
| 01-06 | Supermarket | 63.00 | -0- | 63.00 |
| 01-14 | Gasoline | 15.00 | -0- | 15.00 |
| 01-18 | Appliance Store | 750.00 | -0- | 750.00 |
| 01-24 | Gasoline | 18.00 | -0- | 18.00 |
| 01-30 | Restaurant | 33.00 | -0- | 33.00 |
| | TOTAL | 984.00 | 80.00 | 904.00 |

RATIO USING TWO AVAILABLE ACCOUNT BALANCES—DEPLETION EXAMPLE MAINTAINING A MINIMUM BALANCE—SPLIT TRANSACTIONS NOT PERMITTED—This example shows where the end user uses a ratio of 100% of the available cash balance, where upon depletion of the cash balance, the end user permits the available credit balance to take over; however, the end user does not allow transactions to be split between the available cash and the available credit balance in the event of a depleted account condition. This example also demonstrates $20 being withheld as a minimum cash balance amount that precludes the $20 from being used for purchase transactions. Being that split transactions are not permitted, the $11 cash balance is not used after the transaction dated 01-05 due to the fact that none of the month's remaining transactions are less than or equal to $11.

| Date | Description | Amount | Cash | Credit |
|---|---|---|---|---|
| AVAILABLE CASH BALANCE OF THE DEBIT | | | | |
| CASH ACCOUNT PORTION - $100.00; CASH | | | | |
| BALANCE NOT PERMITTED TO GO BELOW $20.00 | | | | |
| 01-02 | Restaurant | 48.00 | 48.00 | -0- |
| 01-03 | Gasoline | 21.00 | 21.00 | -0- |
| 01-05 | Shoe Store | 36.00 | -0- | 36.00 |

| | |
|---|---|
| 01-05 | $11 AVAILABLE CASH ($31 minus $20 |
| | minimum threshold) IS LESS THAN |
| | TRANSACTION AMOUNT |

| | | | | |
|---|---|---|---|---|
| 01-06 | Supermarket | 63.00 | -0- | 63.00 |
| 01-14 | Gasoline | 15.00 | -0- | 15.00 |
| 01-18 | Appliance Store | 750.00 | -0- | 750.00 |
| 01-24 | Gasoline | 18.00 | -0- | 18.00 |
| 01-30 | Restaurant | 33.00 | -0- | 33.00 |
| | TOTAL | 984.00 | 69.00 | 915.00 |

RATIO USING THREE AVAILABLE ACCOUNT BALANCES—More than two accounts can be employed in a given ratio, such as where 33.33% (one-third) of the transaction amount debits an available cash balance, 33.33% debits available credit balance #1, and 33.33% debits available credit balance #2, as will be seen in the following chart example for a month's transaction activity:

| | Description | Amount | Cash | Credit #1 | Credit #2 |
|---|---|---|---|---|---|
| 01-02 | Restaurant | 48.00 | 16.00 | 16.00 | 16.00 |
| 01-03 | Gasoline | 21.00 | 7.00 | 7.00 | 7.00 |
| 01-05 | Shoe Store | 36.00 | 12.00 | 12.00 | 12.00 |
| 01-06 | Supermarket | 63.00 | 21.00 | 21.00 | 21.00 |
| 01-14 | Gasoline | 15.00 | 5.00 | 5.00 | 5.00 |
| 01-18 | Appliance Store | 750.00 | 250.00 | 250.00 | 250.00 |
| 01-24 | Gasoline | 18.00 | 6.00 | 6.00 | 6.00 |
| 01-30 | Restaurant | 33.00 | 11.00 | 11.00 | 11.00 |
| | TOTAL | 984.00 | 328.00 | 328.00 | 328.00 |

Another parameter of the transaction processor comprises having at least one amount threshold, where an end user can elect to have all transactions up to, say, $50 debit an available cash balance, and have all transactions above $50 debit an available credit balance.

Amount Threshold Using Two Available Account Balances

Transactions up to $50 are debited from the available cash balance using a 100% ratio (all cash) while transactions above $50 are debited from the available credit balance using a 100% ratio (all credit)—

| Date | Description | Amount | Cash | Credit |
|---|---|---|---|---|
| 01-02 | Restaurant | 48.00 | 48.00 | -0- |
| 01-03 | Gasoline | 21.00 | 21.00 | -0- |
| 01-05 | Shoe Store | 36.00 | 36.00 | -0- |
| 01-06 | Supermarket | 63.00 | -0- | 63.00 |
| 01-14 | Gasoline | 15.00 | 15.00 | -0- |
| 01-18 | Appliance Store | 750.00 | -0- | 750.00 |
| 01-24 | Gasoline | 18.00 | 18.00 | -0- |
| 01-30 | Restaurant | 33.00 | 33.00 | -0- |
| | TOTAL | 984.00 | 171.00 | 813.00 |

In the above example, remember that it is just as easy to set the parameters of the transaction processor to where transactions up to $50 are debited from the available credit balance using a 100% ratio (all credit), while transactions above $50 are debited from the available cash balance using a 100% ratio (all cash).

Taking the example further, more than one amount threshold can be used, using two accounts (one available cash balance, one available credit balance), where the varied thresholds comprise different ratios (hence the term at least one ratio). For example, the transaction processor can be set to where all transactions up to $50 debit the available cash balance using a 100% ratio (all cash); for transactions above $50 and up to $100, 50% is debited from the available cash balance while 50% is debited from the available credit balance; and all transactions above $100 debit the available credit balance using a 100% ratio (all credit).

Using these particular parameters, an individual can go out for lunch, and by swiping the card at a point of sale can have the $12 cost of a lunch debited only from his available cash balance; then, by swiping the same card at another point of sale can have the $70 cost of a pair of shoes debited in equal amounts from his available cash balance and available credit balance; then, by swiping the same card at yet another point of sale can have the $1500 cost of a laptop computer be debited only from his available credit balance. Be reminded that the parameters comprising the transaction processor handled the varied accounts debiting without any account selection or purchase payment division taking place or being necessary at any of the points of sale. Also, in the case of the 50/50 available cash balance/available credit balance transaction, two separate account balances were debited using only one swipe of the card, and with no special instructions needing to be entered at the point of sale terminal. Also notable is the fact that the nature of the actual varied accounts being debited (available cash balance versus available credit balance) in each of the three transactions was absolutely invisible to each of the point of sale merchants.

More than One Amount Threshold Using Varied Ratios and Two Available Account Balances

For transactions up to and including $50, 100% of the transaction is debited from the available cash balance (all cash). For transactions above $50 up to $100, 50% of the transaction is debited from the available cash balance while 50% is debited from the available credit balance. For transactions above $100, 100% of the transaction is debited from the available credit balance (all credit).

| Date | Description | Amount | Cash | Credit |
|---|---|---|---|---|
| 01-02 | Restaurant | 48.00 | 48.00 | -0- |
| 01-03 | Gasoline | 21.00 | 21.00 | -0- |
| 01-05 | Shoe Store | 36.00 | 36.00 | -0- |
| 01-06 | Supermarket | 63.00 | 31.50 | 31.50 |
| 01-14 | Gasoline | 15.00 | 15.00 | -0- |
| 01-18 | Appliance Store | 750.00 | -0- | 750.00 |
| 01-24 | Gasoline | 18.00 | 18.00 | -0- |
| 01-30 | Restaurant | 33.00 | 33.00 | -0- |
| | TOTAL | 984.00 | 202.50 | 781.50 |

A slightly more complex example is where transactions up to and including $50 have 50% of the transaction debited from the available cash balance while 50% is debited from the available credit balance. For transactions above $50, 25% (one-quarter) is debited from the available cash balance while 75% (three-quarters) is debited from the available credit balance.

| Date | Description | Amount | Cash | Credit |
|---|---|---|---|---|
| 01-02 | Restaurant | 48.00 | 24.00 | 24.00 |
| 01-03 | Gasoline | 21.00 | 10.50 | 10.50 |
| 01-05 | Shoe Store | 36.00 | 18.00 | 18.00 |
| 01-06 | Supermarket | 63.00 | 15.75 | 47.25 |
| 01-14 | Gasoline | 15.00 | 7.50 | 7.50 |
| 01-18 | Appliance Store | 750.00 | 187.50 | 562.50 |
| 01-24 | Gasoline | 18.00 | 9.00 | 9.00 |
| 01-30 | Restaurant | 33.00 | 16.50 | 16.50 |
| | TOTAL | 984.00 | 288.75 | 695.25 |

Another system component of debiting available account balances is by using what will be known as the remainder threshold. An example will be presented using two accounts (one available cash balance, one available credit balance). In a simple example, all transactions up to $50 debit the available cash balance using a 100% ratio (all cash); for transactions above $50, the first $50 is debited from the available cash balance, while 100% the remainder amount above the first $50 (the total amount minus the first $50) is debited from the available credit balance. Taking the example further, an additional remainder threshold can be placed resulting where the first $50 of a transaction is debited from the available cash balance, while the remainder amount above the first $50 but below, say, the first $100 (the total amount minus the first $50) uses a ratio where 50% of the remainder debited from the available cash balance, and 50% of the remainder debited from the available credit balance; while any remainder above the first $100 debits the available credit balance using a 100% ratio (all credit).

Reiterating the earlier example using these particular parameters, the individual swiping the card at a point of sale at lunch can have the $12 cost of the lunch debited only from his available cash balance; then, when swiping the same card at another point of sale, the $70 cost of a pair of shoes has the first $50 debited from the available cash balance, and the remainder of $20 debited in equal amounts from his available cash balance and available credit balance ($10 each account), with the end result being that the $70 transaction has $60 (the first $50 plus half of the remainder amount above $50, which is $10; $50+$10=$60) debited from the available cash balance, with the remaining $10 being debited from the available credit balance; then, by swiping the same card at yet another point of sale for the $1500 laptop computer purchase, the first $50 is debited from the available cash balance, whereas the remainder amount after the first $50 up to the first $100 has a 50/50 available cash/available credit account debit, whereas the $1400 remainder amount above the first $100 debits only the available credit balance. The end result for the laptop purchase has the transaction debiting $75 of the available cash balance (the first $50, plus half of the remainder amount above $50 up to $100, which is $25; $50+$25=$75), and $1425 debiting the available credit balance (half of the remainder amount above $50 up to $100, which is $25, and all of the remainder amount above $100, which is $1400; $25+$1400=$1425).

Remainder Threshold Using Two Available Balances

Transaction amounts up to $30 are debited from the available cash balance while remainder amounts above $30 are debited from the available credit balance—

| Date | Description | Amount | Cash | Credit |
|---|---|---|---|---|
| 01-02 | Restaurant | 48.00 | 30.00 | 18.00 |
| 01-03 | Gasoline | 21.00 | 21.00 | -0- |
| 01-05 | Shoe Store | 36.00 | 30.00 | 6.00 |
| 01-06 | Supermarket | 63.00 | 30.00 | 33.00 |
| 01-14 | Gasoline | 15.00 | 15.00 | -0- |
| 01-18 | Appliance Store | 750.00 | 30.00 | 720.00 |
| 01-24 | Gasoline | 18.00 | 18.00 | -0- |
| 01-30 | Restaurant | 33.00 | 30.00 | 3.00 |
| | TOTAL | 984.00 | 204.00 | 780.00 |

As analogous to earlier examples, the transaction processor can just as easily be set to where transaction amounts up to $30 are debited from the available credit balance while remainder amounts above $30 are debited from the available cash balance.

It could be desirable to combine aspects of amount threshold and remainder threshold. For instance, using an available cash balance and an available credit balance, the transaction processor could be set up where transactions up to and including $100 have, say, the first $30 of the transaction debited from the available cash balance, and have any remainder amount above $30 debited from the available credit balance, whereas transactions over $100 have the total amount debited entirely from the available credit balance, with no part of the transaction amount being debited from the available cash balance.

Combination Amount Threshold and Remainder Threshold Using Two Available Balances

Transaction amounts up to $30 are debited from the available cash balance while remainder amounts above $30 up to $100 are debited from the available credit balance, while transactions over $100 have the entire amount debited from only the available credit balance—

| Date | Description | Amount | Cash | Credit |
|---|---|---|---|---|
| 01-02 | Restaurant | 48.00 | 30.00 | 18.00 |
| 01-03 | Gasoline | 21.00 | 21.00 | -0- |
| 01-05 | Shoe Store | 36.00 | 30.00 | 6.00 |
| 01-06 | Supermarket | 63.00 | 30.00 | 33.00 |
| 01-14 | Gasoline | 15.00 | 15.00 | -0- |
| 01-18 | Appliance Store | 750.00 | -0- | 750.00 |
| 01-24 | Gasoline | 18.00 | 18.00 | -0- |
| 01-30 | Restaurant | 33.00 | 30.00 | 3.00 |
| | TOTAL | 984.00 | 174.00 | 810.00 |

Amount threshold and remainder threshold features of the transaction processor may each be used in terms of more than two available account balances.

More than One Amount Threshold Using Three Available Account Balances

Transactions up to and including $50 are debited from the available cash balance, while transactions above $50 and up to $100 are debited from available credit balance #1, while transactions over $100 are debited from available credit balance #2—

| Date | Description | Amount | Cash | Credit #1 | Credit #2 |
|---|---|---|---|---|---|
| 01-02 | Restaurant | 48.00 | 48.00 | -0- | -0- |
| 01-03 | Gasoline | 21.00 | 21.00 | -0- | -0- |
| 01-05 | Shoe Store | 36.00 | 36.00 | -0- | -0- |
| 01-06 | Supermarket | 63.00 | -0- | 63.00 | -0- |
| 01-14 | Gasoline | 15.00 | 15.00 | -0- | -0- |
| 01-18 | Appliance Store | 750.00 | -0- | -0- | 750.00 |
| 01-24 | Gasoline | 18.00 | 18.00 | -0- | -0- |
| 01-30 | Restaurant | 33.00 | 33.00 | -0- | -0- |
| | TOTAL | 984.00 | 171.00 | 63.00 | 750.00 |

### More than One Remainder Threshold Using Three Available Account Balances

An example using remainder thresholds for three available account balances is where all transaction amounts up to $50 debit an available cash balance, any remainder amounts above $50 up to $100 debit available credit balance #1, and any remainder amounts above $100 debit available credit balance #2. Using these particular parameters, a single transaction for $150 would be spread across three separate available balances, with the first $50 portion of the transaction debiting the available cash balance, the second $50 portion debiting available credit balance #1, and the final $50 portion debiting available credit balance #2. Analogous system component may be used for embodiments employing more than three accounts.

| Date | Description | Amount | Cash | Credit #1 | Credit #2 |
|---|---|---|---|---|---|
| 01-02 | Restaurant | 48.00 | 48.00 | -0- | -0- |
| 01-03 | Gasoline | 21.00 | 21.00 | -0- | -0- |
| 01-05 | Shoe Store | 36.00 | 36.00 | -0- | -0- |
| 01-06 | Supermarket | 63.00 | 50.00 | 13.00 | -0- |
| 01-14 | Gasoline | 15.00 | 15.00 | -0- | -0- |
| 01-18 | Appliance Store | 750.00 | 50.00 | 50.00 | 650.00 |
| 01-24 | Gasoline | 18.00 | 18.00 | -0- | -0- |
| 01-30 | Restaurant | 33.00 | 33.00 | -0- | -0- |
| | TOTAL | 984.00 | 271.00 | 63.00 | 650.00 |

Note that the transaction dated 01-06 made use of two available account balances while the transaction dated 01-18 made use of all three available account balances.

Amount Threshold and Ratio Illustration Using Four Available Account Balances

This example is provided to demonstrate that the transaction processor can manage basically one or more of available account balances and blending of parameters. For transactions up to $50, 50% of the transaction is debited from available cash balance #1, while 50% is debited from available credit balance #1; however, transactions above $50 have 25% of the transaction debited from available cash balance #2, while the remaining 75% is debited from the available credit balance #2—

| Date | Description | Amount | Cash #1 | Cash #2 | Credit #1 | Credit #2 |
|---|---|---|---|---|---|---|
| 01-02 | Restaurant | 48.00 | 24.00 | -0- | 24.00 | -0- |
| 01-03 | Gasoline | 21.00 | 10.50 | -0- | 10.50 | -0- |
| 01-05 | Shoe Store | 36.00 | 18.00 | -0- | 18.00 | -0- |
| 01-06 | Supermarket | 63.00 | -0- | 15.75 | -0- | 47.25 |
| 01-14 | Gasoline | 15.00 | 7.50 | -0- | 7.50 | -0- |
| 01-18 | Appliance | 750.00 | -0- | 187.50 | -0- | 562.50 |
| | Store | | | | | |
| 01-24 | Gasoline | 18.00 | 9.00 | -0- | 9.00 | -0- |
| 01-30 | Restaurant | 33.00 | 16.50 | -0- | 16.50 | -0- |
| | TOTAL | 984.00 | 85.50 | 203.25 | 85.50 | 609.75 |

Before the next discussion commences, what needs to be understood is that parameters such as ratio, threshold, minimum balance, etc. can be continually changed at will. For example, at the beginning of a new billing cycle, an end user can elect to have transactions debit 50% available cash and 50% available credit, while in the middle of the billing cycle the end user can introduce a new threshold parameter, while near the end of the billing cycle, the end user changes a ratio to debit account balances for transactions using 20% available cash and 80% available credit.

Up until this point, transactions have been debited among at least two account balances based on amount parameters. An additional system component of debiting transactions among at least two account balances, which can be employed in addition to, or in place of amount parameters, is by using any merchant identification information to debit transactions among at least two account balances.

In a typical financial card transaction, an account end user presents a financial card to a merchant, who records transaction data by using either an electronic terminal or a manual draft. This transaction data includes the amount of the purchase, the end user's account number, the card's expiration date, the merchant identification number, and the date of the transaction. In the later part of the transaction process, the card issuer posts the transaction to the end user's account. The transaction data posted to the cardholder's account includes merchant identification information, which comprises the name of the merchant, and in many cases an additional identifier, such as a number or actual address, that identifies a particular location of a merchant, where said merchant comprises perhaps a store chain that has numerous locations.

As can be reasonably assumed in many cases, a given end user can become a creature of habit when it comes to frequenting a given merchant. As a result, it may be useful to enable the transaction processor to allow the end user to debit available account balances in a consistent manner for transactions involving said given merchant. For example, an end user may have the transaction processor in his global account set so that transactions up to $50 are debited 100% from an available cash balance (all cash), and transactions over $50 are debited 100% from an available credit balance (all credit). However, when the end user goes food shopping at a particular store, he may prefer that the all transactions at the particular store debit only his available cash balance, regardless of the transaction size. His current parameters would allow the account to perform as wished for food purchases from the merchant up to $50, but not for food purchases over $50.

To solve the dilemma, the end user could perform file maintenance on a special instructions file in the transaction processor that enables any system component or type of merchant identifier information, or any merchant identifier information contained in the merchant identifier text string that appears on the end-user's statement, to be associated with its own set of available account balance debiting parameters. Such information comprises the merchant name, the merchant location such as store number, city, state or country, and in certain cases, the merchant classification code, which classifies a merchant according to the type of business. Upon the transaction being posted to the account, the transaction processor looks for any merchant identifier information that matches information contained in the special instructions file. Upon finding a match, the transaction processor debits the available account balances for the amount of the transaction in accordance with the desired available account balance debiting parameters.

For example, if the end user sets up the merchant name Excellent Grocers into the special instructions file, and sets available account balance debiting parameters for Excellent Grocers, then any transaction postings matching Excellent Grocers will be debited according to said parameters, regardless of store location. If the end user sets up the merchant name Excellent Grocers—First Town, VA, then only those transaction postings originating from the Excellent Grocers store in First Town, Virginia will be debited according to the parameters in the special instruction file, whereas transaction postings originating from the Excellent Grocers store in Second City, Virginia will be debited according to the standard parameters outside of the special instructions file.

The end user can make a special entry for a merchant in the special instructions file, or can simply click on an already posted transaction and have that information transfer to the special instructions file, where the end user can make adjustments with regards to merchant identifier matching parameters, such as specifying that match parameters are to include more than one, or any location of a given merchant, and not just the location listed on the clicked-on transaction, and also where the end user can specify the pertinent available account balance debiting parameters for transactions with that particular merchant or merchant location.

Such flexibility would enable an end user, whose typical transactions up to $50 are set up to debit an available cash balance, to set up an entry in the special instructions file that would allow even a mere $12 transaction with, say, Amazon.com to automatically debit an available credit balance. The special instructions file can be set up so that a list of merchants can share a specific set of account debiting instructions, or one or more of merchants can each have a specific set of account debiting instructions. Such a feature could also prove very useful to end users that enable merchants or service providers to have periodic payments automatically debited from the end user's global account.

Merchant identification information often, if not always, includes two letter state codes (VA for Virginia, NJ for New Jersey, etc.), where the two letter state code tends to appear at the end of the merchant identifier text string, for example ABC BOOKSELLERS LOS ANGELES Calif. In this instance, the special instructions file is set up to recognize state codes, so, for example, transactions comprising out of the area state codes, such as this transaction from California (CA), could be set up to debit the available account balances using specific end-user criteria. State codes are particularly good criteria for geographic sorting, especially since cities from which charges originate from are not always listed in the merchant identifier text string; nonetheless, any system component or type of merchant identifier information, or any information contained in a merchant identifier text string can be associated with its own set of account debiting parameters. For example, states outside of an end user's given tri-state area could be set up for credit only, so in the case of out-of-area fraud, credit protection would help to limit end-user losses. Such could be an attractive feature for individuals that ordinarily only do transactions that debit available cash balances, such as debit card transactions, because while some debit card issuers currently offer fraud protection that limits end-user liability with regard to debit card purchases, many debit card issuers do not. With regard to geographic listings, it would be helpful to have an option to structure a listing on the special instructions file where an end user can make a choice to list states, or even countries for that matter, where the special out-of-state or out-of-country account debiting parameters do not apply, which in many cases could be a much shorter list, and save the end user from having to make entries excluding maybe 47 or 48 state codes, and who knows how many country codes.

The next section covering a critical aspect of the transaction processor is how an incoming transaction or incoming transaction authorization request is handled. In this regard, the transaction processor may handle an incoming transaction/authorization request using two distinct methods. Depending on the embodiment, a card issuer may choose one method over the other, where the end user is left with no option, or a card issuer may offer both methods, and allow the end user to make an election, where the choice is stored in the transaction processor, and can be changed at will. In fact, it could be possible for a global account to offer both methods, where an end user can assign different methods to, say, different amount thresholds.

The first method is where a request for a transaction authorization comes in, and the transaction processor looks at the total available balances of the at least two the available account balances. If the total of the available account balances is inadequate for a given transaction, then the transaction authorization request is rejected. If the total is adequate for a given transaction, then the transaction request is authorized, and then the accounts are debited using Best Fit criteria, either in real time if the transaction is performed on line via the ACH, or on a non real-time basis once the transaction posts using any off-line network. For example, if a given transaction's total is authorized for $100 based on the total of two available balances (one being an available cash balance, the other being an available credit balance), and the parameters in the transaction processor instruct that half of the amount ($50) is to debit the available cash balance and the other half is to debit the available credit balance, and each of the two available balances is adequate, then the transaction is debited equally from the two accounts. However, if, the available cash balance is only $30, then the available credit balance must have at least $70 left on it because the total $100 transaction was authorized based on the total of the available balances. At this point, using Best Fit criteria, the available cash balance is debited $30 (instead of the $50 the parameters called for), and the available credit balance is debited $70 (the $50 the parameters called for, plus the $20 that the available cash balance couldn't cover).

The second method is where, say, a $100 transaction authorization request comes in, where the global account comprises an available cash balance and an available credit balance. The transaction processor is set up to debit 50% available cash balance and 50% available credit balance. Using the second method, the transaction processor looks at the two account balances individually, so if the available cash balance has at least $50, and the available credit balance has at least $50, the $100 transaction will be authorized. If one of the accounts is inadequate, a user-selectable parameter comes into play called Rescue or Reject, where the end user can pre-select, in the case of where one of the assigned account balances is inadequate, to either have the transaction processor try to rescue the transaction by having the transaction processor attempt to compensate for a deficiency in the inadequate account using the unused available account balance of the other account, or to reject the transaction based on the one account balance's shortfall. Should the end user choose the rescue function, and another available account balance is able to make up the shortfall, then the transaction request will be authorized (or in the case of a real-time ACH embodiment, the transaction itself will be consummated); however, if the end user chooses the rescue function, and there isn't enough of another available account balance to make up for the shortfall of the inadequate account balance, then the transaction will be rejected.

Either or both methods may be employed for end user accounts comprising two, or more than two, available account balances. As suggested earlier, each of the two methods may be used in the global account for different parameter sets.

Other optional parameters of the transaction processor are geared for convenience, user spending discipline, and/or security measures. One is where an end user can specify to transfer funds from any available cash balance(s) to make any payment(s) due, such as the minimum payment due, a specified amount, the entire amount due, etc., on transaction amounts were charged against any available credit balance(s). The transfer may be set up to occur automatically, or the end user may perform each transfer individually.

Another is where an end user can specify minimum and/or maximum transaction amounts, for a particular transaction. A minimum transaction amount of, say, $10 could help discipline an end user to not use the global financial account for every little impulse purchase, so the transaction processor is set up to reject transactions under $10. A maximum transaction amount could also enable discipline, or may be employed purely as a security measure, especially for global accounts that have multiple users. For example, if an end user sets up a maximum transaction amount for a single transaction of $499, then transactions above $499 will be rejected.

Maximums can be set up for total debiting of all of the available account balances comprising the global account within a specified time frame, so any transaction that would push the total amount above, say, $1000 before the last day of the billing cycle would get rejected. Here, the end user specifies amounts and timeframe. The timeframe may comprise any time specification, so the timeframe can be a specific date, a specific day within the billing cycle (by the date the billing cycle ends), a rolling time period (as in do not exceed $1000 usage within the 7 days prior to and including today's date), etc.

Maximums for any of the individual available account balances comprising the global account also are useful for end users trying to control spending. Keeping this in mind, the transaction processor enable limits to be set over any specified timeframe on the maximum allowable available account balance usage for at least one available account balance comprising the global account. For instance, in an example comprising an available cash balance and an available credit balance, the transaction processor is set to use a threshold parameter where transactions over $100 automatically debit the available credit balance. However, an end user may not wish to use any more than $500 of his available credit balance within a given billing cycle. Therefore, the end user would place a $500 limit for the entire current billing cycle timeframe on usage of his available credit balance. In such an instance, the end user can choose, or the card issuer/account provider can provide, parameter options such as Best Fit and/or Rescue or Reject criteria to deal with transactions that conflict with an available account balance that has already reached its maximum allowable available account balance usage. In this case, after the $500 available credit balance usage limit is reached, any new transaction(s) over $100 using Best Fit criteria would automatically debit the available cash balance until depletion, whereas with any new transaction(s) over $100 using Rescue or Reject criteria, the end user could choose to either rescue the new transaction by using the available cash balance, or reject the transaction based on the fact that the specified maximized usage limit of the available credit balance had already been reached.

Specified timeframes may be as long as or even longer than a billing cycle, or may be much shorter. For example, timeframes may be short enough to be expressed in terms of hours. Such creates a very interesting possibility where an end user can specify, say, a 24 hour period starting at 5:00 AM Eastern Standard Time, where, using amount and timeframe parameters, the end user limits the accessing of the available cash balance to $100 per 24 hour period starting at 5:00 AM EST, to where anything above $100 debits an available credit balance (based on Best Fit, or based on a rescue instruction as part of Rescue or Reject); or simply rejects should the end user so desire (based on a reject instruction as part of Rescue or Reject). In the case of the sample parameter, once 5:00 AM EST rolls around (a new 24 hour period), the ability to access the available cash balance resets, and the end user can again debit the available cash balance up to $100 before the abovementioned circumstances occur. The time at which an account is accessed corresponds to either the time a transaction is authorized (in the case of a transaction that posts at a time separate from authorization), or the time a transaction actually clears in a real-time situation, such as transactions done using the ACH.

Specified timeframes are not only useful for limiting account balance maximum usage; they are also useful as criteria for adjusting account-debiting parameters. For example, the end user can adjust parameters on the transaction processor so that purchases made from 5 AM EST until 11 AM EST debit the available cash balance using a 100% ratio; purchases made from 11 AM EST until 4 PM EST debit an available cash balance and an available credit balance in a 50%-50% ratio; while purchases made from 4 PM EST until 5 AM EST the next morning debit the available credit balance using a 100% ratio. This way, an end user pays for his $3.50 morning latte using an available cash balance; a $20 dry cleaning bill is paid at lunchtime using a 50%-50% ratio of available cash/available credit; and a night on the town is covered using his available credit balance. All of the varied account debiting at each point of sale is performed automatically when swiping the card, and not by performing any manipulations at any of the points of sale. In these situations, and as mentioned in prior examples, Best Fit and/or Rescue or Reject criteria may be used to help the end user avoid embarrassment at any of the points of sale.

Another parameter comprises the capability to disengage at least one given available account balance. For example, an end user may wish to disengage an available cash balance as a security measure when going on vacation. However, should the end user find himself in a bind while on vacation, access to the transaction processor, via a phone call to a customer service representative, via the Internet, etc., will enable him to turn back on the available cash balance.

Another parameter for security is quite simple, and comprises where the transaction processor sends E-mail to the end user every time the available account balances are used. This way, an end user not only has a running record on account balances usage; better yet, the end user has a basis for detecting unauthorized account balances usage.

Many of the transaction processor's available account balance debiting capabilities can be adapted to facilitate cash withdrawals, electronic payments or wires, and/or checks (drafts). For example, an end user could set up the transaction processor parameters comprising ratio, threshold, remainder, etc., with a threshold parameter so that cash withdrawals up to $200 debit an available cash balance, while cash withdrawals above $200 debit only an available credit balance, thus behaving like a cash advance against an available credit balance. Remainder thresholds can be employed, so for a cash withdrawal of $400, the first $200 debits an available cash balance, while the $200 remainder debits an available credit balance. Ratio parameters can also be used, so a cash withdrawal can debit 100% of an available cash balance, and, upon depletion of the available cash balance, can make use, along with various threshold and remainder amount parameters, of the Best Fit or Rescue or Reject criteria disclosed earlier. It certainly helps an end user that needs cash fast to be able to rely on more than one available balance, especially when the balances work seamlessly and invisibly thanks to the transaction processor. Also, among the at least two available account balances may optionally be a separate cash balance that is used only for cash withdrawals, and not for purchases. The cash withdrawal parameters comprising ratio, threshold, remainder, etc., can comprise the non-purchase available cash balance along with other available balances that enable the employment of the Best Fit or Rescue or Reject criteria as well, thereby enabling the end user to easily withdraw cash even upon the depletion of the non-purchase available cash balance.

Electronic and wire payments can be sent using finds that debit the at least two accounts automatically in manners similar to cash withdrawals using parameters such as ratio, threshold, remainder threshold, etc. In fact, the transaction processor can set up repeating electronic and wire payment instructions so that a given set of electronic and wire payment instructions has its own set of available balance debiting parameters with regard to ratio, threshold, remainder threshold, etc.

Checks (drafts) drawn on the global account can receive similar treatment with regard to parameters comprising ratio, threshold, remainder, etc., such as where parameters on the transaction processor can be set up using a threshold parameter so check amounts up to a certain amount, such as $500, debit an available cash balance, and checks over the amount debit an available credit balance, and act like the cash advance or convenience checks that some credit card companies send out occasionally with monthly billing statements. The Best Fit or Rescue or Reject criteria disclosed earlier may be also adapted for drafts so at least two available account balances can help ensure that the chances of a given check bouncing are significantly reduced. As with the cash withdrawal embodiment, the global account may optionally comprise a separate available cash balance that is available only for clearing checks, where the check clearing available cash balance may optionally use other available account balances to enable debiting parameters comprising ratio, threshold, remainder, etc., and/or to enable the employment of the Best Fit or Rescue or Reject criteria.

Another aspect that is widely discussed in consumer arenas is free or reduced fee checking. Some checking account customers receive free or reduced fee checking services based on maintaining a minimum balance in the account that enables the checking account provider to earn revenue, thus making up for the costs of offering a checking account. Other checking account providers allow free checking with direct deposit of the end user's wages, pensions, or government benefits. The present invention presents an interesting opportunity for embodiments that comprise a checking feature. Using available credit balances and/or available cash balances in an off-line transaction (a transaction not using the ACH system) results in fees for the card issuer/account provider. For example, card issuers absolutely love revenue from interchange fees, as revenues over time are quite substantial. To encourage end user loyalty, the card issuer can offer free or reduced fee checking based on a specified amount of off line fee or revenue generating activity, such as interchange fees, or in cases such as American Express, where revenues that are deducted and earned from merchant transactions are not technically considered to be interchange fees, where basically if the end user performs a specified amount total and/or number of transactions within a specified period using at least one available credit and/or available cash balance, where the transactions generate fees or revenue, then the end user will receive free or reduced fee checking services. Also, the method may be modified to where the end user receives free or reduced fee checking services based on the amount of on line fee generating activity (using the ACH) within a specified period, either in addition to, or in place of, off line fee or revenue generating activity. Furthermore, the term any revenue generating activity is intended to optionally include interest that is either paid by end users, and/or is owed by end users, on any kind of outstanding or unpaid credit balances that are due, either in addition to, or in place of any other types of transaction related fees or revenues. Such free or reduced fee checking offer may be used in place of a minimum deposit or direct deposit requirement; or the checking services provider can choose instead to offer the end user free or reduced fee checking services if the end user either performs a given amount of transactions within a specified period that generates fees or revenue, maintains a minimum deposit, or sets up direct deposit (Three Ways to Get Free Checking!).

A powerful feature of the transaction processor is where a given transaction that is already posted may be switched from one already debited balance to another available balance. The following example shows a list of posted transactions where 50% of the transaction amount debited an available cash balance, while the remaining 50% debited an available credit balance.

| Date | Description | Amount | Cash | Credit |
|---|---|---|---|---|
| 01-02 | Restaurant | 48.00 | 24.00 | 24.00 |
| 01-03 | Gasoline | 21.00 | 10.50 | 10.50 |
| 01-05 | Shoe Store | 36.00 | 18.00 | 18.00 |
| 01-06 | Supermarket | 63.00 | 31.50 | 31.50 |
| 01-14 | Gasoline | 15.00 | 7.50 | 7.50 |
| 01-18 | Appliance Store | 750.00 | 375.00 | 375.00 |

When viewing the postings on 01-26, the end user determines that he would like to have more available cash in his global account, and in making the determination feels that he would like to revise the 01-18 Appliance Store purchase so that the entire $750 debits the available credit balance, which will return the $375 cash that was previously debited from his available cash balance.

To perform this operation, the end user clicks on the 01-18 Appliance Store transaction, highlights by clicking on the $375 cash in the cash debit column, and enters zero. The transaction processor checks the available credit balance, sees that the available credit balance can adequately handle an additional $375 debit, and automatically readjusts the debit on the available credit balance to read $750. In essence, the end user can enter an amount greater than zero, which would still leave some residual amount debiting the available cash balance for the 01-18 transaction, and would readjust the debit to the available credit balance accordingly. While in most cases it is desirable for the transaction processor to make the amount readjustments automatically in response to a revision entered by the end user, there could be embodiments where more than one adjustment amount could be entered manually, with the transaction processor then verifying that the total correctly adds up and then checking the available account balance(s) to see if the account balance(s) have the resources to allow the change before the readjustment is permitted. While such embodiments comprising manual entries can be used for global accounts comprising only two available account balances, such manual entry capabilities are especially useful for embodiments comprising three or more available account balances, where a readjustment to one account balance by the end user requires a non-obvious offset using at least one of the two or more remaining accounts. For example, if an end user wishes to make a readjustment that frees up $100 in one available account balance, and has a choice of using two other available account balances to offset the $100 amount, how that $100 is taken from the two remaining account balances is non-obvious, and thus requires the end user to actually specify the desired amount change(s) to either or both of the two remaining available account balances. The example mentioned earlier in the paragraph is as follows:

| Date | Description | Amount | Cash | Credit |
|---|---|---|---|---|
| 01-18 | Appliance Store | 750.00 | -0- | 750.00 |

The end result is where the end user now has an extra available $375 cash balance thanks to the transfer. It is very important to keep in mind that the $375 is not a cash advance; rather, it is merely a restoration of a prior cash balance. There are no real implications here with regard to back interest. Assuming a grace period is in place, there is a chance that the extra $375 debit to the available credit balance will be paid off before interest is assessed. In the event that the grace period does not apply, then the card issuer can charge interest on the extra $375 from the date that the available credit balance is debited by the extra $375. Whether or not a feature fee, or a per-use fee, is charged for this end user feature is basically up to the card issuer/account provider.

What happens if the opposite were to occur, where the end user wants to free up more of the available credit balance? On 01-26, the end user clicks on the 01-18 Appliance Store transaction, highlights by clicking on the $375 credit debit column, and enters zero. The transaction processor checks the available cash balance, sees that the available cash balance can adequately handle an additional $375 debit, and automatically (in an automatic embodiment) readjusts the debit on the available cash balance to read $750, while at the same time is crediting the available credit balance by $375.

| Date | Description | Amount | Cash | Credit |
|---|---|---|---|---|
| 01-18 | Appliance Store | 750.00 | 750.00 | -0- |

In this situation, there could be implications here with regards to back interest. If a grace period applies, then no back interest should be due; however, if a grace period does not apply, then there are 8 days of back interest that could still be due. Being that the transaction posted back on 01-18, and the change was made on 01-26, the customer could be charged 8 days interim interest on the $375 that was borrowed from the available credit balance and paid to the appliance store merchant. In such a case it could be anyone's guess on how a card issuer/account provider would view such a situation, especially if the card issuer/account provider is earning revenue all along on a long-standing and sizable available cash balance belonging to the customer that was the source of the $375 used to credit the customer's available credit balance.

It is also possible with the transaction processor to highlight a grouping of posted transactions, and reset any of the global parameters such as ratio, amount threshold, remainder threshold, etc., and have all the posted transactions readjust.

For instance, instead of the transactions debiting the available cash and available credit balances 50%-50%, as the example below, the end user can highlight, say, the last four transactions . . .

| Date | Description | Amount | Cash | Credit |
|---|---|---|---|---|
| 01-02 | Restaurant | 48.00 | 24.00 | 24.00 |
| 01-03 | Gasoline | 21.00 | 10.50 | 10.50 |
| 01-05 | Shoe Store | 36.00 | 18.00 | 18.00 |
| 01-06 | Supermarket | 63.00 | 31.50 | 31.50 |
| 01-14 | Gasoline | 15.00 | 7.50 | 7.50 |
| 01-18 | Appliance Store | 750.00 | 375.00 | 375.00 |

Then reset the global parameters so the highlighted transactions are readjusted to where the 50%-50% ratio is replaced with, say, a remainder threshold where transaction amounts up to $20 debit the available cash balance, and remainder amounts above $20 debit the available credit balance. The resulting account debiting of the posted transactions, assuming adequate available account balances, are as follows:

| Date | Description | Amount | Cash | Credit |
|---|---|---|---|---|
| 01-05 | Shoe Store | 36.00 | 20.00 | 16.00 |
| 01-06 | Supermarket | 63.00 | 20.00 | 43.00 |
| 01-14 | Gasoline | 15.00 | 15.00 | -0- |
| 01-18 | Appliance Store | 750.00 | 20.00 | 730.00 |

The net change to the two account balances is where the available cash balance is credited $357, while the available credit balance is debited $357. As mentioned earlier, the credited cash is a restoration of what was in the available cash balance, which is good for the card issuer/account provider, being that the card issuer/account provider makes money on both the cash parked in the account, and on the increased credit usage. Resetting the parameters globally may comprise any of the parameters, such as ratio, amount threshold, remainder threshold, etc.

A question here is whether the end user can make these readjustments after the billing cycle closes. It is certainly possible for the transaction processor to enable posted transactions to remain accessible for readjustment after the billing cycle closes, but it is not without difficulties. One consideration includes system capabilities. Another consideration involves where end users that carry a large credit balance due can become especially confused by the shear number of past transactions presented, which could tax customer services resources considerably. While there is certain value to being able to make readjustments to transactions up to the close of the billing cycle, the value of offering such accommodations after the close of the billing cycle certainly diminish, while the difficulties in offering such post-billing cycle readjustments certainly increase. Nonetheless, it is disclosed that an end user can make post-billing cycle readjustments, should the offering card entity/account provider choose to allow it.

Should a purchase return to a merchant be necessary, the transaction processor is able to record transactions by retaining merchant information combined with the amount of a given transaction, further combined with a record of how the accounts were debited at the time of the transaction, so an incoming credit for a return hits the varied account balances the same way the original transaction debited the balances. For example, if a credit is sent from merchant X for $21.50, the transaction processor scans the file for a record of the transaction totaling $21.50 from merchant X. Upon locating a match for the merchant and the amount, the credit is portioned among the account balances either 1) the same way it was originally debited from the account balances, or 2) if the posted transaction was readjusted by the end user, by using the readjusted parameters. Whichever method is used may either be selectable by the end user, or may be predetermined by the card issuer/account provider.

If all transactions for a given merchant are debited using the same account balance debiting parameters, with none of the parameters being changed, and none of the posted transactions being readjusted, then there is no problem determining the parameters to use for crediting the refund from the merchant. If there is more than one transaction from the same merchant for the same amount, and the parameters were changed, or the transactions were readjusted, then the determination on which transaction the refund is crediting can be made on a first in, first out (FIFO) or last in, first out (LIFO) basis. Again, the method used may be selectable by the end user, or predetermined by the card issuer/account provider. Date is not a reliable matching parameter, because, depending on the capabilities of the various merchant systems used, returning credits may or may not include the date of the original transaction. Certainly, date matching will help such matters immeasurably once it becomes universal. The situation for determining parameters to use for crediting a return become even more complicated on partial returns. If there is only one transaction for a given merchant, it may be assumed somewhat safely that even though the amount of the partial return credit does not match the original transaction amount, the partial return credit does indeed pertain to the singular transaction. Another way of determining the transaction a partial return pertains to, and thus which parameters will be used for crediting, is by having the transaction processor look at the amount. If there are three transactions with a given merchant, and the partial return credit is greater than two of the transactions, but less than the third, then it may be assumed that the partial return pertains to that third transaction. If the partial return appears that it could belong to more than one transaction, then a determination can be made using either a FIFO or LIFO basis as to which crediting parameters are to be used.

It is reasonable for returns to be processed using the same parameters that were used to perform the original transaction, especially since other methods could create opportunities for abuse. For example, if an end user were allowed to specify that all returns are to credit the available cash balance, there would be little preventing the end user from charging large amounts using the available credit balance, returning those items, having the returned finds credit his available cash balance, withdrawing cash from the available cash balance, and basically using his credit balance for a fee free cash advance. In such a situation, chances are good that the interest rate on the consumed credit balance is less than the interest rate on a cash advance, so the issuer would lose not once (on the cash advance fee) but twice (on the cash advance fee, and the lower interest rate charged on the consumed credit balance).

Controlling all of this capability is the interface. In most cases, it is desirable for the actual end user to be able to use the interface directly; however, it is possible for an embodiment to comprise where the end user uses the interface indirectly, such as where the end user calls up a customer service representative, and the customer service representative, acting as an intermediary, makes the actual changes to the global account or transaction processor using an interface on behalf of the end user.

Whatever the situation, the interface may comprise the usage of any communicative system component, format or technology, from any location. For example, the end user can access the interface via the Internet, by calling a customer service representative, by using use a menu driven phone system where the changing of parameters such as account debiting parameters is enabled by punching numbers on a phone (a tele-account system), via an intranet at the branch of the card-issuing bank, by fax, mail, etc.

It is foreseeable that such parameter changes could be performed at a point of sale terminal; however, such an embodiment requires special equipment and programming, and could be difficult due to the expense and the level of cooperation needed to become widespread. Besides, having an end user toil with parameters at a point of sale terminal goes against the spirit of the present invention, which is basically to swipe and go, where having the transaction processor automatically perform specialized functions eliminates having to go through various rituals at a point of sale terminal.

An end user that wishes to make changes to the transaction processor regarding the debiting of the at least two available account balances and other parameters in a purchase environment can simply use a cell phone to either call up a customer service representative or access a tele-account system, or use a handheld personal assistant that enables wireless Internet access, and make the desired changes to the transaction processor in real-time before his purchases are tallied. Such capability saves time at the actual point of sale, is less taxing on the cashier, and is much more considerate of the other customers standing in line. The fact that the facilitating of capabilities with regard to account debiting and other parameters requires absolutely no special point of sale manipulations or equipment is viewed as advantageous.

As mentioned earlier, the second embodiment of the transaction processor comprises the use of a smart data card embodiment. Smart data card embodiments used in point of sale environments require special point of sale equipment to take full advantage of the varied capabilities. For this application, the type of smart data card needed is a microprocessor card, which contains a microprocessor semiconductor chip. The smart data card links together and controls at least two available account balances, and enables a given transaction to be debited from the at least two available account balances from a point of sale terminal according to parameters discussed in the global account embodiment, such as at least one ratio, at least one amount threshold, at least one remainder threshold, and where parameters in the smart data card enable at least one given available account balance to be disengaged, minimum available balance parameters to be set, and maximum allowable transaction amounts to be set.

The smart data card embodiment of the transaction processor can be used with any combination of accounts, regardless of whether they are in-house or out-of-house to the entity that issues the smart data card. In fact, it is entirely possible for the provider of the smart data card to be a third-party entity that is in no way responsible for any of the available account balances accessible via the smart data card. In such an embodiment, the smart data card is programmed to access the available account balances using the various account numbers of the available account balances. For example, the microprocessor on the smart data card can be programmed to analyze an incoming transaction amount at a point of sale, and using a 50%-50% ratio debit the available cash account balance at institution #1 for half of the transaction amount while debiting an available credit balance at institution #2 for the remaining half of the transaction. Using a threshold example, the microprocessor on the smart data card can be programmed to automatically debit an available cash balance at institution #1 for transactions up to $50, and to debit an available credit balance at institution #2 for transactions above $50.

Also, the microprocessor on the smart data card can be programmed to debit available account balances according to Best Fit or Rescue or Reject criteria discussed earlier.

As is known in the art, a smart data card may be programmed, and parameters can be selected and/or modified using a smart data card interface. The smart data card interface may be part of, at the site of, or away from the site of the actual point of sale terminal.

While the transaction processor is envisioned to provided the end user great flexibility with regard to how a given transaction is debited from different available account balances, the it is possible that the entity that offers and administers the disclosed financial card account, or that offers the smart data card embodiment described herein, could elect to give an end user numerous options and choices, or could choose to pare down the capabilities available to the end user considerably. Also, said entity could choose to have certain parameters pre-established, where such parameters either possess or lack the capability to be changed or otherwise modified by the end user. As a result, embodiments and features of this invention can vary a great deal in the real world, depending on which capabilities a given offering entity chooses to provide and/or allow.

The present invention is described by way of the summary, description and examples presented herein, but is not limited to the specific description, but includes all alternative potential variations of the invention that can be made available to end-users as would be apparent to those skilled in the art.

1. A method for executing at least one debit for at least one point of sale financial transaction using at least one preset transaction parameter relating the debit amount of said debit to the relative account balances in at least two available balances in at least one financial account, comprising:
(a) providing at least two available balances in at least one financial account that can be accessed for said debit for said at least one point of sale transaction; and
(b) debiting said debit amount for said at least one point of sale transaction from said at least one of said account balances based on at least one of said preset transaction parameters relating said debit amount to the amounts or ratios of each of said account balances in at least two of said available account balances,
wherein said preset transaction parameter is at least one selected from a ratio, an amount threshold, a remainder threshold, a minimum available account balance, a maximum available account balance, a minimum debit amount, a range of debit amounts, a maximum debit amount, or any combination thereof.

2. A method according to claim 1, wherein said debit is conducted using a transaction card.

3. A method according to claim 2, wherein said transaction card is a magnetic stripe card.

4. A method according to claim 2, wherein said transaction card is a smart card.

5. A method according to claim 1, wherein said debit is conducted using a personal identification system.

6. A method according to claim 5, wherein said personal identification system is at least one selected from a personal identification number (PIN), a signature, an electronic signature, a fingerprint, a retinal scan, a DNA test, and face or feature recognition.

7. A method for executing at least one debit for at least one point of sale financial transaction using at least one preset transaction parameter relating said debit amount to the relative account balances in at least two available balances in at least one financial account, comprising:
(a) maintaining said at least two available balances in at least one financial account that can be debited remotely via a transaction processor according to at least one preset transaction parameter that relates said debit amount to the relative balances in at least two of said available account balances;
(b) processing a request for authorization of said transaction amount against said at least two available account balances, in exchange for goods or services,
wherein said transaction amount requested is authorized when at least one selected from
i. the total of said at least two available account balances is greater than or equal to said debit amount;
ii. at least one selected available account balance, as determined by said transaction processor, is greater than or equal to said assigned portion of said debit amount corresponding to said at least one selected available account balance; or
iii. at least one selected available account balance, as determined by said transaction processor, is able to compensate for a deficiency in at least one other selected available account balance that is less than the assigned portion of said debit amount corresponding to said at least one selected available account balance using Rescue or Reject criteria, where said assigned portion is determined by said transaction processor; and
wherein said transaction amount is debited from or credited to said at least one available account balances by at least one selected from
i. according to the assigned portion determined by said transaction processor
ii. according to at least one Best Fit criteria;
iii. according to said assigned portion; and
iv. according to Rescue or Reject criteria.

8. A method of claim 7, further comprising including where said available account balances are accessed from a point of sale via at least one automated clearing house (ACH) network.

9. A method of claim 7, further comprising including where said available account balances are accessed from a point of sale via a proprietary network other than an ACH network.

10. A method of claim 7, further comprising including where said available account balances are accessed from a point of sale via the Internet.

11. A method of claim 7, further comprising including where said at least two available account balances comprise one or more of available in-house cash balances or available in-house credit balances.

12. A method of claim 7, further comprising including where said at least two available account balances comprises one or more of available out-of-house cash balances or available out-of-house credit balances in addition to said available in-house cash balances or said available in-house credit balances.

13. A method of claim 7, further comprising including where said at least two available account balances comprises one or more of available out-of-house cash balances or available out-of-house credit balances.

14. A method of claim 7, further comprising including where at least one of the available account balances comprising said at least two available account balances has its own account number that enables access via a credit card, debit card, ATM card, draft, and the like, where said account number is distinct from the account number(s) used to access said global account.

15. A method of claim 7, further comprising including where said available account balances allow a given end user of said account benefits and reward programs that are available to financial card accounts.

16. A system for at least one debit for at least one point of sale financial transaction using at least one preset transaction parameter relating said debit amount to the relative account balances in at least two available balances in at least one financial account, comprising:
(a) a system component for maintaining said at least two available balances in at least one financial account that can be debited remotely via a transaction processor according to at least one preset transaction parameter that relates said debit amount to the relative balances in at least two of said available account balances;
(c) a system component for processing a request for authorization of said transaction amount against said at least two available account balances, in exchange for goods or services,
wherein said transaction amount requested is authorized when at least one selected from
i. the total of said at least two available account balances is greater than or equal to said debit amount;
ii. at least one selected available account balance, as determined by said transaction processor, is greater than or equal to said assigned portion of said debit amount corresponding to said at least one selected available account balance; or
iii. at least one selected available account balance, as determined by said transaction processor, is able to compensate for a deficiency in at least one other selected available account balance that is less than the assigned portion of said debit amount corresponding to said at least one selected available account balance using Rescue or Reject criteria, where said assigned portion is determined by said transaction processor; and
wherein said transaction amount is debited from or credited to said at least one available account balances by at least one selected from
v. according to the assigned portion determined by said transaction processor
vi. according to at least one Best Fit criteria;
vii. according to said assigned portion; and
viii. according to Rescue or Reject criteria.

17. A system of claim 16, further comprising including where said at least one two available account balances are accessed from a point of sale via at least one ACH network.

18. A system of claim 16, further comprising including where said at least one two available account balances are accessed from a point of sale via a proprietary network other than at least one ACH network.

19. A system of claim 16, further comprising including where said at least one two available account balances are accessed from a point of sale via the Internet.

20. A system of claim 16, further comprising including where said at least two available account balances comprises one or more of available in-house cash balances or available in-house credit balances.

21. A system of claim 16, further comprising including where said at least two available account balances comprise one or more of available out-of-house cash balances or available out-of-house credit balances in addition to said available in-house cash balances or said available in-house credit balances.

22. A system of claim 16, further comprising including where said at least two available account balances comprises one or more of available out-of-house cash balances or available out-of-house credit balances.

23. A system of claim 16, further comprising including where at least one of the available account balances comprising said at least two available account balances has its own account number that enables access via a credit card, debit card, ATM card, draft, and the like, where said account number is distinct from the account number(s) used to access said global account.

24. A system of claim 16, further comprising including where said at least one two available account balances allow a given end user account benefits and reward programs provided by financial card accounts.

25. An apparatus comprising a transaction processor that links together and controls at least two available account balances in at least one financial account that enable preset transaction parameters to be selected or modified with regard to how a given transaction is debited among at least two available account balances, where said parameters comprise at least one ratio, and where said transaction processor allows file maintenance functions to be performed, where said parameters can be selected or modified, and said file maintenance functions are performed using an interface.

26. An apparatus of claim 25, further comprising including where said parameters comprise at least one amount threshold.

27. An apparatus of claim 25, further comprising including where said parameters comprise at least one remainder threshold.

28. An apparatus of claim 25, further comprising including where said parameters enable said end user to allow split transactions in a depleted account condition.

29. An apparatus of claim 25, further comprising including where said transaction processor enables said end user or said card entity to make changes or modifications to said parameters via said interface using a communicative system component, format, or technology, from any location, wherein said interface comprises any communicative system component, format, or technology.

30. An apparatus of claim 25, further comprising including where said transaction processor comprises a special instructions file comprising where specific account debiting parameters are associated with any type of merchant identifier information, or any merchant identifier information contained in the merchant identifier text string.

31. An apparatus of claim 30, further comprising including where said special instructions file enables state codes or country codes contained in said merchant identifier information to be set up with specific account debiting parameters.

32. An apparatus of claim 25, further comprising including where said parameters enable at least one given available account balance to be disengaged.

33. An apparatus of claim 25, further comprising including where said parameters enable minimum available balance parameters to be set.

34. An apparatus of claim 25, further comprising including where said parameters enable minimum or maximum allowable transaction amounts to be set.

35. An apparatus of claim 25, further comprising including where said parameters enable limits to be set on the maximum total debiting of said at least two available account balances over any specified timeframe.

36. An apparatus of claim 25, further comprising including where said parameters enable account-debiting parameters to be adjusted according to specified timeframes.

37. An apparatus of claim 25, further comprising including where said parameters enable limits to be set on the maximum allowable available account balance usage for at least one available account balance comprising said at least two accounts over any specified timeframe; further comprising including where said parameters comprise Best Fit or Rescue and Reject capabilities to deal with any transaction(s) that conflict with said maximum allowable available account balance usage.

38. An apparatus of claim 25, further comprising including where said transaction processor enables a transfer of payment amounts from any available cash balance(s) to make any payment(s) due on transaction amounts charged against any available credit balance(s), comprising where said transfer of said payment amounts are set to occur automatically, or where the end user expedites each said transfer individually.

39. An apparatus of claim 25, further comprising including where said transaction processor sends E-mail when said available account balances are used.

40. An apparatus of claim 25, further comprising including where said transaction processor enables separate parameters for cash withdrawals.

41. An apparatus of claim 25, further comprising including where said transaction processor enables separate parameters for check clearance.

42. An apparatus of claim 25, further comprising including where said at least two available account balances comprises an available cash account specifically for cash withdrawals.

43. An apparatus of claim 25, further comprising including where said at least two available account balances comprises an available cash account specifically for check clearance.

44. An apparatus of claim 25, further comprising including where said file maintenance functions enable readjustment or revision with regard to how said given transaction is debited among said at least two available account balances on a post real-time basis after a transaction is posted or otherwise consummated, either by readjusting global parameters, or by revising actual amounts.

45. An apparatus of claim 25, further comprising including where said transaction processor records transaction debiting parameters in order to properly credit returned purchases.

46. An apparatus of claim 25, comprising where said interface comprises any format or technology, comprising where said interface may be used directly by the end user, or on behalf of said end user, and comprising where access to said interface comprises any format or technology.

47. An apparatus of claim 25, further comprising including where said transaction comprises the use of a financial card.

48. An apparatus of claim 25, further comprising including where said transaction comprises a cash withdrawal.

49. An apparatus of claim 25, further comprising including where said transaction comprises the use of a draft.

50. An apparatus of claim 25, further comprising including where said transaction comprises the use of an electronic or wire payment.

51. An apparatus of claim 50, further comprising including where said transaction processor sets up electronic and wire payment instructions so that a given set of said electronic and wire payment instructions has its own set of available balance debiting parameters with regard to ratio, threshold, remainder threshold, etc.

52. A method where a checking account provider enables an end user to receive free or reduced fee checking services based on the amount of off line fee or revenue generating activity, where if said end user performs a specified amount total and/or number of transactions within a specified period using at least two available credit or available cash balances, where said transactions generate any fee or revenue, then said end user will receive said free or reduced fee checking services.

53. A method of claim 52, further comprising including where said checking account provider enables said end user to receive said free or reduced fee checking services based on the amount of on line transaction fee or revenue generating activity, either in addition to, or in place of, said off line fee or revenue generating activity, where if said end user performs a specified amount total and/or number of transactions within a specified period using at least one available credit or available cash balance, where said transactions generate any fee or revenue, then said end user will receive said free or reduced fee checking services.

54. An apparatus comprising a transaction processor that resides on a smart data card that links together and controls at least two available account balances in at least one financial account, where said smart data card enables a given transaction to be debited from said at least two available account balances from a point of sale terminal according to parameters, where said parameters comprise at least one ratio, and where said parameters can be selected or modified using a smart data card interface, and where said at least two available account balances comprises any combination of in-house or out-of-house available account balances.

55. An apparatus of claim 54, further comprising including where said parameters comprise at least one amount threshold.

56. An apparatus of claim 54, further comprising including where said parameters comprise at least one remainder threshold.

57. An apparatus of claim 54, further comprising including where said parameters enable at least one given available account balance to be disengaged.

58. An apparatus of claim 54, further comprising including where said parameters enable minimum available balance parameters to be set.

59. An apparatus of claim 54, further comprising including where said parameters enable minimum or maximum allowable transaction amounts to be set.

60. An apparatus of claim 54, further comprising including where said parameters enable Best Fit or Rescue or Reject criteria.

61. An apparatus of claim 54, further comprising where said smart data card interface is part of, is at the site of, or is away from the site of said point of sale terminal.
